(19) United States
(12) Patent Application Publication
(10) Pub. No.: US 2004/0249665 A1
(43) Pub. Date: Dec. 9, 2004

(54) System and method for processing and managing claim forms

(76) Inventor: Lindee David, Toronto (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 10/456,556

(22) Filed: Jun. 9, 2003

(51) Int. Cl. G06F 17/60

(52) U.S. Cl. 705/2; 705/4

(57) ABSTRACT

The invention provides a system and method for processing and managing medical insurance claim forms. A computer software system is provided for implementing the system and method. A user of the computer software system may use it to retrieve data about patient, physicians, and insurance providers from data bases provided by the computer software system and enter retrieved data automatically into claim forms for submission to an insurance provider. Documentation for seeking pre-approval of a treatment, making insurance claims, or appeal rejection of claims by an insurance provider may be generated using the software system. Claim processing status, whether a claim is submitted and still pending, rejected, appealed, or approved, may be tracked and managed using the computer software system. The computer software system also provides access to both legal and medical reference information to justify or support an insurance claim.

### FIELD OF INVENTION

The invention relates generally to the field of insurance reimbursement. In particular, the invention relates to computer software for processing and preparing forms and applications for drug-related reimbursement claims from insurance providers.

### BACKGROUND OF INVENTION

A patient's costs for many medical treatments, including medications provided during the treatments, are covered by insurance policies provided by insurance providers. Insurance reimbursements may come from private insurers, provincial or state government institutions, federal government institutions, or some other sources. Each different insurance provider will often have (or require the user of) a claim form unique to the provider. Generally, to make a claim for reimbursement of the costs, a unique claim form provided by the insurance provider needs to be submitted. Typically, a patient provides general patient-information and the patient's physician provide medical information about the patient. Based on information submitted with the claim form, the insurance provider may approve or reject the claim. For patients requiring prolonged and extensive treatment, for example, cancer or HIV/AIDS patients, frequent submissions of claim forms may be necessary. The forms may also be lengthy or complex to fill in. It may not be practical to ask these patients to complete all of these claim forms themselves. Nor is it usually an easy task for physicians to complete claim forms for all their patients. Administratively, it also may not be feasible for physicians, or other health care professionals, to track the process status of a large number of insurance claims for their patients. This problem may become even more severe if certain claims for reimbursement are rejected by insurance providers and appeal documentation needs to be generated for reconsideration of the claims by the insurance providers. The collection of data concerning the overall success of the claims process for multiple patients may be onerous as well.

Software systems are presently available that automate limited aspects of claim form preparation related tasks. They provide entry of patient, physician and insurance related data and format that data into a format suitable for submission to an identified insurance company. However, prior art systems do not effectively handle ancillary information related to a claim, such as reference information and do not track information relating to a claim after its submission. Nor do they provide a complete package of customized forms, including an appropriate covering letter.

The foregoing creates challenges and constraints for health care professionals for processing and preparing insurance claim forms. There is therefore a need for an automated system and method for processing and managing medical insurance claims as compared to the existing art.

### SUMMARY OF INVENTION

In a first aspect, a system for preparing and tracking an insurance claim for an insurance provider of many providers for a pharmaceutical product for a patient is provided. The system comprises a database and a software system operating on a computer. The database stores patient information relating to the patient, claim information relating to the insurance claim, provider information relating to the insurance providers and product information relating to the pharmaceutical product. The software system allows entry and processing of the patient information, claim information, provider information and product information. The software system can receive the patient information from a user, enter claim information utilizing in part the patient information and track a status of the insurance claim as it is processed by the insurance provider.

The system may generate a claim package for the insurance claim. The claim package may comprise a claim form selected by the software system relating to the insurance provider populated by data in the patient information and a covering letter addressed to the insurance provider providing further information relating to the patient and the pharmaceutical product.

The product information comprises dosage information, treatment information and clinical study information.

The software system may be adapted to selectively include the clinical study information as further information in the covering letter.

The software system may track the status of the insurance claim as being one of at least being pending, filed, and rejected.

The software system may be further adapted to selectively generate an appeal package after the status of the insurance claim is set to being rejected. The appeal package may comprise an appeal covering letter providing further information from the clinical study information.

The software system may be further adapted to generate a status report comprising claim status information relating to claims prepared for the patients.

The software system may be further adapted to track physicians of patients that file insurance claims relating to the pharmaceutical product to the plurality of insurance providers and the database contains physician information relating to the physicians.

The software system may be further adapted to generate a report based one of a condition relating to the pharmaceutical product, the patient and one of the physicians.

The database may store the patient information, the claim information, the provider information, the product information and the physician information in tables and the software system may be adapted to access and process the tables using SQL constructs.

In a second aspect a method of preparing and tracking an insurance claim for an insurance provider identified from a plurality of insurance providers for a pharmaceutical product for a patient from a plurality of patients is provider. Therein, a status of the insurance claim being prepared is stored in a database accessible by a software system operating on a computer and the software system is adapted to receive data relating to the insurance claim and to generate a claim package relating to the insurance claim. The method comprises the steps of: receiving the patient information from a user by the software system; providing product information relating to the pharmaceutical product for inclusion in the claim package for selection by the user; generating the claim package utilizing the received patient information and product information; tracking a status of the insurance claim; and updating the status upon a user being notified of approval or rejection of the insurance claim.

In the method the product information may comprises dosage information, treatment information and clinical study information. Further, the method may provide the clinical study information into the insurance claim documentation in a form letter.

In a third aspect of the invention, there is provided a method of assessing a patient, and preparing and tracking an insurance claim for an insurance provider identified from a plurality of insurance providers for a pharmaceutical product identified by the assessment for treatment of the patient from a plurality of patients, a status of the insurance claim being stored in a database accessible by a software system operating on a computer, the software system adapted to receive data relating to the insurance claim and to generate a claim package relating to the patient assessment and the insurance claim, the method comprising the steps of receiving patient assessment information from a user by the software system; providing diagnosis information based on the patient assessment information; providing treatment information based on the diagnosis; and when the treatment information identifies a pharmaceutical product, receiving the patient information from a user by the software system; providing product information relating to the pharmaceutical product for inclusion in the claim package for selection by the user; generating the claim package utilizing the received patient information and product information; tracking a status of the insurance claim; and updating the status upon a user being notified of approval or rejection of the insurance claim.

In other aspects the invention provides various combinations and subsets of the aspects described above.

### BRIEF DESCRIPTION OF DRAWINGS

For the purposes of description, but not of limitation, the foregoing and other aspects of the invention are explained in greater detail with reference to the accompanying drawings, in which:

FIG. 1 is a schematic diagram illustrating conceptual steps followed by a health care professional through a life cycle of processing an insurance claim form in an embodiment;

FIG. 2 illustrates schematically functional components of a software system implementing the method described in reference to FIG. 1;

FIG. 3A shows an exemplary start-up screen generated by the software system of FIG. 2;

FIG. 3 shows an exemplary Drug Benefits screen generated by the software system of FIG. 2;

FIGS. 4A, 4B and 4C are representative views of data entry forms generated by the software system of FIG. 2;

FIG. 5 shows an input screen for entering clinical information generated by the software system of FIG. 2;

FIG. 5A shows another input screen generated by the software system of FIG. 2 for entering clinical information relevant to an HIV/AIDS patient;

FIG. 6 shows a screen for entering symptoms and transfusion information generated by the software system of FIG. 2;

FIG. 7 shows a screen for entering therapy information generated by the software system of FIG. 2;

FIGS. 8A and 8B show screens displayed for generating claim documentation by the software system of FIG. 2;

FIG. 8C shows a claim form typical of the forms generated and printed by the software system of FIG. 2;

FIG. 8D shows a letter typical of the letters generated and printed by the software system of FIG. 2;

FIG. 9 shows a screen generated by the software system of FIG. 2 displaying information about pending claims;

FIG. 9A shows a dialogue box generated by the software system of FIG. 2;

FIG. 10 shows a screen generated by the software system of FIG. 2 for a user to select product reference materials;

FIGS. 11A, 11B, and 11C show screens displayed by the software system of FIG. 2 showing information specific to a particular insurance provider;

FIG. 12 shows a screen generated by the software system of FIG. 2 displaying selectable lists of physicians, patients, pharmacies, payers, letters library, and results of claim submissions;

FIG. 12A shows a screen displaying a summary report on claim status generated by the software system of FIG. 2;

FIG. 13 is a schematic diagram illustrating a software system interfaced with patient modules as an alternative embodiment to the software system of FIG. 2;

FIG. 14 shows a portion of the screen of patient module PBCC for interfacing with the software system of FIG. 13;

FIG. 15 shows a continuation portion of the screen of FIG. 14;

FIG. 16 shows a continuation portion of the screen of FIG. 14;

FIG. 17 shows a continuation portion of the screen of FIG. 14;

FIG. 18 shows a continuation portion of the screen of FIG. 14;

FIG. 19 shows a continuation portion of the screen of FIG. 14;

FIG. 20 shows a continuation portion of the screen of FIG. 14;

FIG. 21 shows a patient information screen generated by patient module SMC for interfacing with the software system of FIG. 13;

FIG. 22 shows a Tools screen generated by the SMC module for interfacing with the software system of FIG. 13;

FIG. 23 shows another Tools screen generated by the SMC module for interfacing with the software system of FIG. 13;

FIG. 24 shows another Tools screen generated by the SMC module for interfacing with the software system of FIG. 13;

FIG. 25 shows another Tools screen generated by the SMC module for interfacing with the software system of FIG. 13;

FIG. 26 shows another Tools screen generated by the SMC module for interfacing with the software system of FIG. 13;

FIG. 27 shows Symptoms & Intervention screen generated by the SMC module for interfacing with the software system of FIG. 13;

FIG. 28 shows another Symptoms & Intervention screen generated by the SMC module for interfacing with the software system of FIG. 13;

FIG. 29 shows EPREX screen generated by the SMC module for interfacing with the software system of FIG. 13;

FIG. 30 shows the Transfusions screen generated by the SMC module for interfacing with the software system of FIG. 13;

FIG. 31 shows the Education screen generated by the SMC module for interfacing with the software system of FIG. 13; and

FIG. 32 shows the Nurse's Notes screen generated by the SMC module for interfacing with the software system of FIG. 13.

### DETAILED DESCRIPTION OF EMBODIMENTS

The description which follows, and the embodiments described therein, are provided by way of illustration of an example, or examples, of particular embodiments of the principles of the present invention. These examples are provided for the purposes of explanation, and not limitation, of those principles and of the invention. In the description which follows, like parts are marked throughout the specification and the drawings with the same respective reference numerals.

The present invention relates to a system and method for processing and preparing forms and applications for medical insurance claims in general, and drug-related reimbursement claims in particular, and is used for seeking reimbursement from insurance providers. In an embodiment, the system is provided in software operating on a computer system. The software may be used by health care providers to manage the insurance reimbursement process for their patients. The software system includes patient assessment tools, reference materials to assist physicians to prescribe a treatment for the illness diagnosed, and claim generation and reimbursement tracking tools to generate and manage insurance claim submissions.

Typically, as a first step, a physician use the patient assessment tools to diagnose a patient. The physician enters the patient's medical information into the patient assessment tools. The patient assessment tools assess the patient's medical conditions based on the information entered and help the physician to diagnose the patient. The patient assessment tool may also suggest possible treatments or medication for the illness diagnosed. Once the physician has a diagnosis of the patient's medical condition, as a second step, the physician prescribes a treatment or a medication for the patient. The physician may refer to the reference materials provided by the system to select or decide an appropriate prescription for the patient. Once a prescription is given, as a third step, the system helps the physician to generate insurance claim documentation for submission. Claim documentation may be in the form of a insurance claim form, a letter from the physician, or both. The medical information of the patient and the prescription given by the physician, already available on the system, are used by the system to generate insurance claim documentation. The system also stores the generated claim documentation for later tracking of status of the insurance claim.

Additionally, the system integrates information and regulations pertaining to both private and government (provincial (or state) and federal) insurance plans, and it generates customized documentation for submitting a claim to one or more of the providers of such insurance plans.

Because of the high integration of the system, combining patient assessment tools, the reference materials and the claim generation and tracking tools into one system, the present invention has the advantages that it reduces the time a physician spends to find out about various reimbursement schemes for any particular drug the physician is prescribing, provides easily accessible information about pharmaceutical products the physician may prescribe for the patient, and provides updated and timely information to assist tracking insurance provider's processing of insurance claims.

The example to be described in detail below is merely one example of a particular embodiment of the present invention. The example provided herein relates to a software system built for handling insurance claims on behalf of cancer patients seeking reimbursement for a special drug, Eprex®, that helps with anemia related to the cancer treatment. Eprex may also be used to treat patients who would otherwise require a blood transfusion. For example, HIV/AIDS or surgery patients may benefit from Eprex. Similar systems may be built for handling insurance claims for HIV/AIDS patients having other ailments, although it should be appreciated that certain details of the software system pertaining to a particular ailment will be different from that to be described below. For example, reference collection may have different contents for a particular disease. Furthermore, software systems embodying the present invention may be built for handling insurance claims for patients having other ailments, requiring other special treatments, or requiring other drugs. Systems embodying the present invention may also be similarly built for handling medical insurance claims in general.

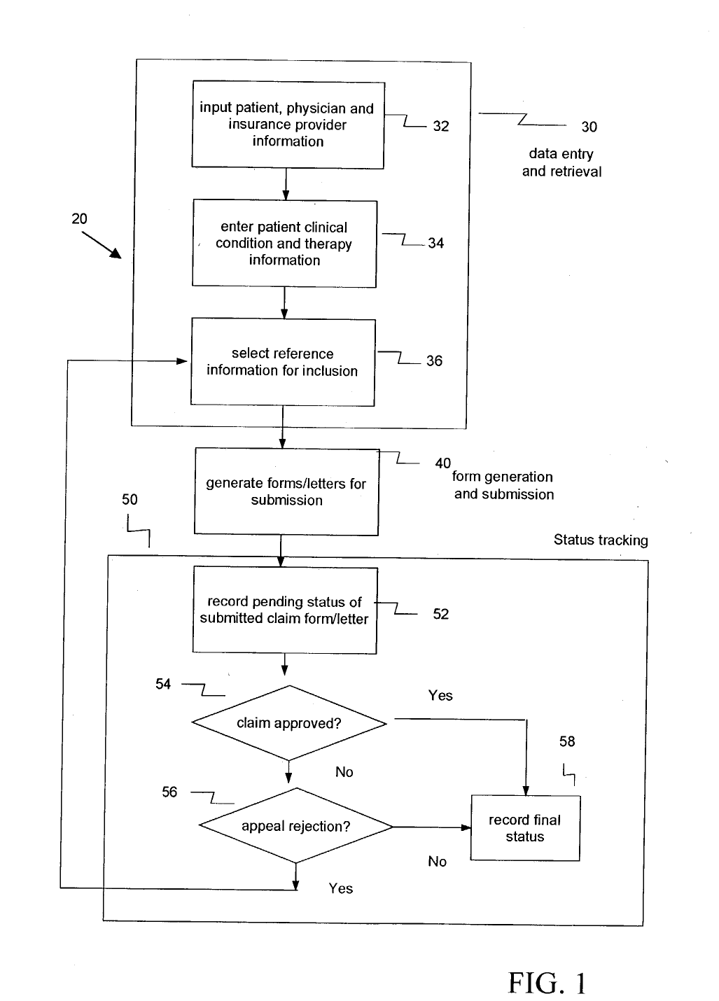

FIG. 1 shows steps a health care professional follows through a life cycle 20 of processing an insurance claim in an embodiment in accordance with the present invention. Broadly speaking, life cycle 20 may be divided into three stages: data entry and retrieval 30, form generation and submission 40, and status tracking 50.

During data entry and retrieval 30 stage, a health care professional first enters, or retrieves from a database system for entering, general information about a patient, the patient's physician, and the patient's insurance provider (step 32). Information of this type, once entered, may be stored in a database of a computer software system for future reuse, thus reducing repetitive administrative work otherwise required. An interface is provided by the software system to permit users to enter general information about a patient, the patient's physician and an insurance provider from which reimbursement is sought.

For purposes of making insurance claims, seeking pre-approvals, or making appeals, patient-related information generally includes medical information, such as clinical study information (relating to diagnosis and treatment), symptoms and a therapy regimen. The health care professional, most likely a patient's physician or nurse, is typically best suited to enter this information (step 34). Where a treatment or therapy regimen is not a routine type, pre-approval may be necessary; or where a claim has been denied, appealing the denied claim may be considered. In situations like these, the physician may prefer to include a supporting letter with the claim, citing or including certain reference information to justify the treatment (step 36). To that end, user selectable and editable citations, such as citations from journal articles, are also provided by the software. For status tracking purposes (step 50), the system preferably automatically records and enters the current date as the submission date (step 52) when claim documentation is printed for submission.

Once all information is entered and citations are selected, the software system generates the claim documentation for the claim (step 40). As indicated, the claim documentation typically includes a claim form, a letter supporting a claim, or both. The claim form preferably has a format identical to that of a standard claim form adopted by the patient's insurance provider. To accommodate different patients who may have different insurance providers, the software system preferably generates claim forms conforming to formats of claim forms adopted by various insurance providers. The software system may also generate a letter to the insurance provider to request reimbursement for costs associated with the treatment prescribed, including costs associated with drugs. The letters provide greater detail of circumstances of the patient and provide justifications for the treatment for which reimbursement is sought. As patients of similar medical conditions may require similar treatments, common statements are provided for such letters. Such letters, once generated, are saved in an electronic library for reference and re-use and possible amendment. Users of the software system may also create their own letters, if appropriate.

The software system tracks pending, approved, and rejected claims and generates processing statistics for claims, including average processing time. Average processing time may be grouped by individual insurance providers or claims associated with individual patients. Status of a claim as recorded by the software system is changed by a health care professional upon being advised of a decision by an insurance provider as to reimbursement (step 54). Depending on the insurance provider's decision, the health care professional may proceed differently and use the software system to track and manage the status of the claim through its life cycle, as outlined below.

If any claim is rejected, the health care professional updates the system recorded status. If an appeal is to be made, the software system also provides assistance to generating appeal documentation for submitting to the insurance provider (step 56). In this regard, further reference materials may need to be cited to support the appeal (step 36) and a letter citing this additional reference information may need to be generated and printed for submission (step 36). The health care professional may decide to generate the appeal documentation at this stage. In a manner similar to the process of generating initial claim documentation, the software system may record the printing date as the submission date of the appeal documentation (step 52). Alternatively, the health care professional may delay the decision to make an appeal for a specified length of time, toward the end of which the software will automatically provide a due date reminder of a possible appeal.

If any claim is approved, the recorded status may be updated to reflect the approval (step 58). The software system may also offer an option of creating a request for continued coverage for similar treatments, for a specified length of time. The information contained in the originally generated claim may be amended, as necessary, for any subsequent claim. The convenient use of previously entered patient-related information can facilitate the reimbursement process.

The software system also provides instructions to enable users to co-ordinate claims from multiple insurance providers for the same treatment, to combine insurance benefits enjoyed by, for example, family members offered by multiple insurance providers.

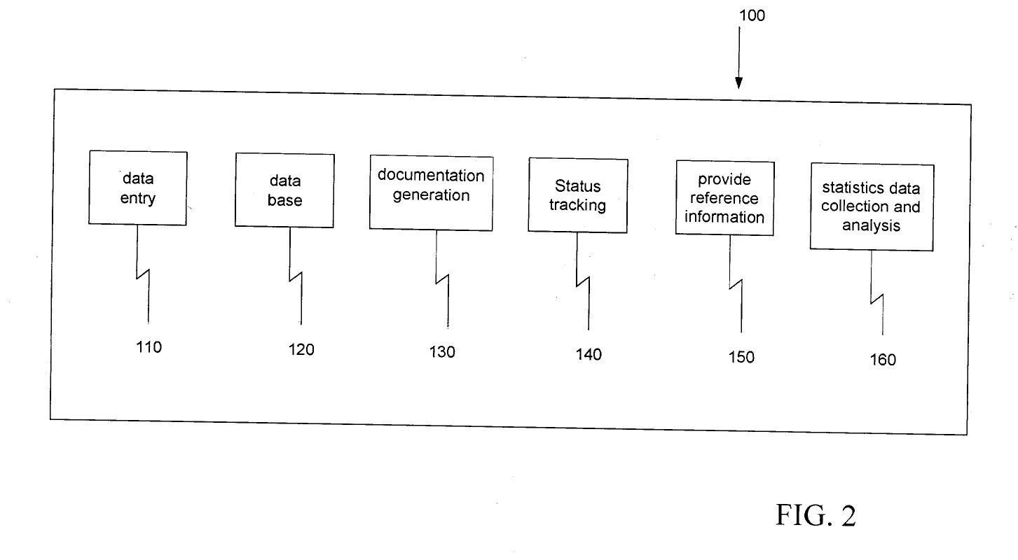

Referring to FIG. 2, functional components of software system 100 of an embodiment are shown. Data entry module 110 generates a user interface for entering patient-related information and pertinent information about physicians and insurance providers. The user interface preferably is a graphic user interface generated on a user's local computer workstation, a remote terminal located in a physician's office, or a web-interface if the software system is web-enabled. Database 120 stores information about patients, physicians, pharmacies, insurance providers, and specialised reference materials. It may be used to retrieve and incorporate stored information into claim documentation. Information stored in database 120 may be retrieved for completing claim forms or used by other modules of system 100. Information about claims and associated claim documentation may be stored in database 120 as well. For example, the information may be stored as individual records. Preferably, data relating to patients, physicians, pharmacies, insurance providers, medical information relating to treatment regimes and other reference information are stored in relational database tables. Records of individual claims may contain links to tables of patient, physician, insurance provider and reference collection. Such database may be queried using, for example, SQL language. Access™ from Microsoft Corporation, for example, may be used to build such database. Other database management systems, of course, may also be used. Database 120 may also be implemented using database models based on, for example, hierarchy or linked list, or using some other database system management technologies. Documentation generation module 130 generates claim/reimbursement documentation for submission to an insurance provider. It also generates the documentation necessary for appealing rejected claims. Status tracking module 140 tracks the status of any submitted claims for reimbursement and any appeals of rejected request for reimbursement, it manages the status of any submitted claims during their life cycle in general, and it provides summary reports on the status of a claim. Reference information module 150 retrieves and enters user-selectable journal citations and legal references. These references are typically included in letters to justify a prescribed treatment, or to support a denied claim where an appeal is made. Data collection and analysis module 160 provides an interface with a central server for collecting statistics data from local software systems located in individual physicians' offices for later analysis. System 100 may also include a module for co-ordinating the submission of claims to multiple co-insurance providers for the same treatment.

In this specification, terms health care professional, health care provider, physician, nurse are used interchangeably. The use of more specific terms does not mean that such specific user is the only one who may use software system 100.

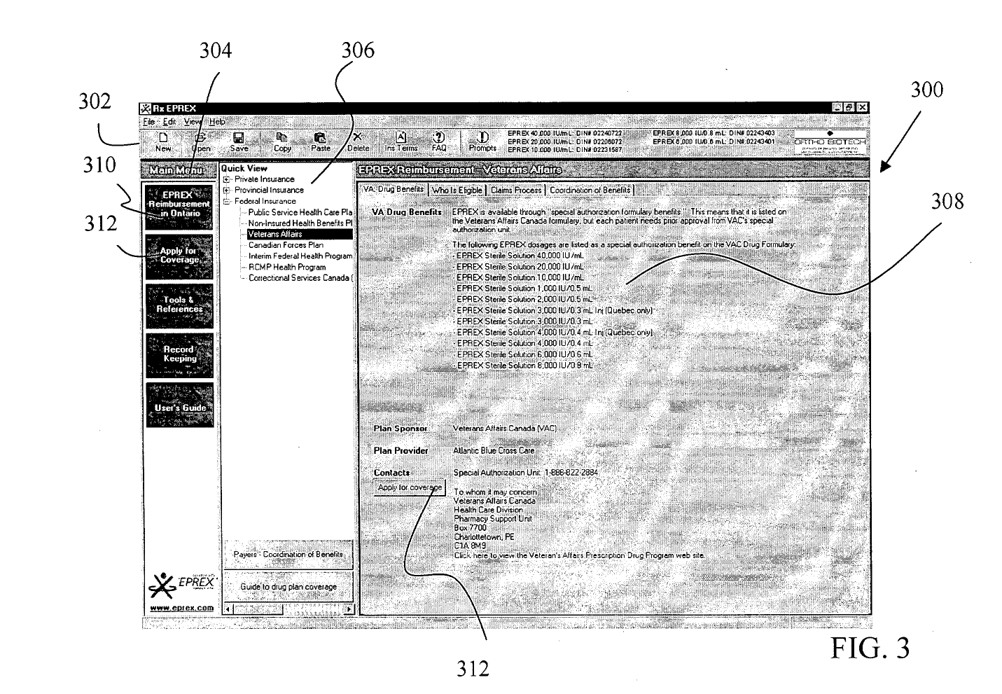

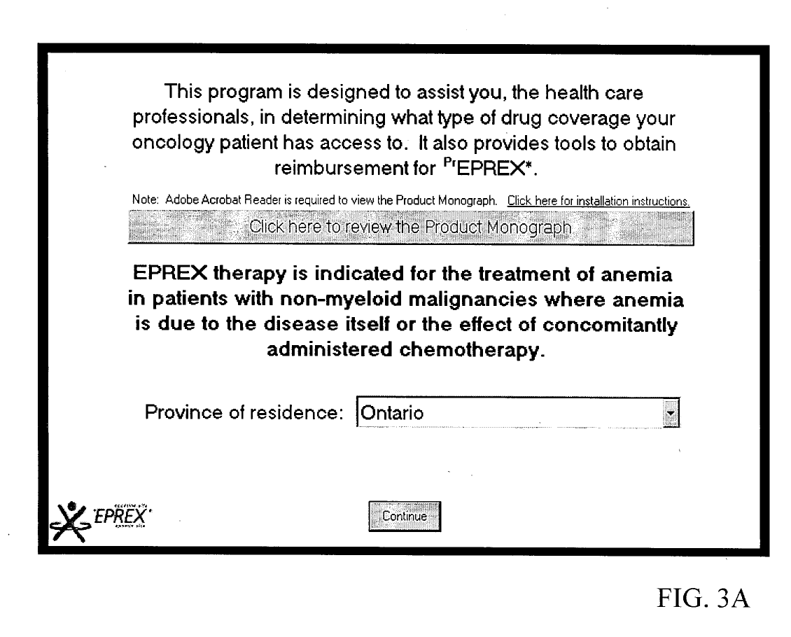

Referring to FIGS. 3A to 8B, there are shown exemplary user interface screens generated by software system 100 in a typical documentation preparation session. Beginning with FIG. 3A, there is shown a start-up screen generated by software system 100. From the start-up screen, a user may select a province of residence. As payer information and insurance policies may vary from province to province, selecting the province of residence at the start of the program allows the software system to load the appropriate payer information for the province selected. A user may change the province of residence later where needed, by selecting the “Record Keeping” tool (to be described later). From this start-up screen, the software system also provides a user the option of viewing the product monograph which may provide systematic and detailed information about the special drug.

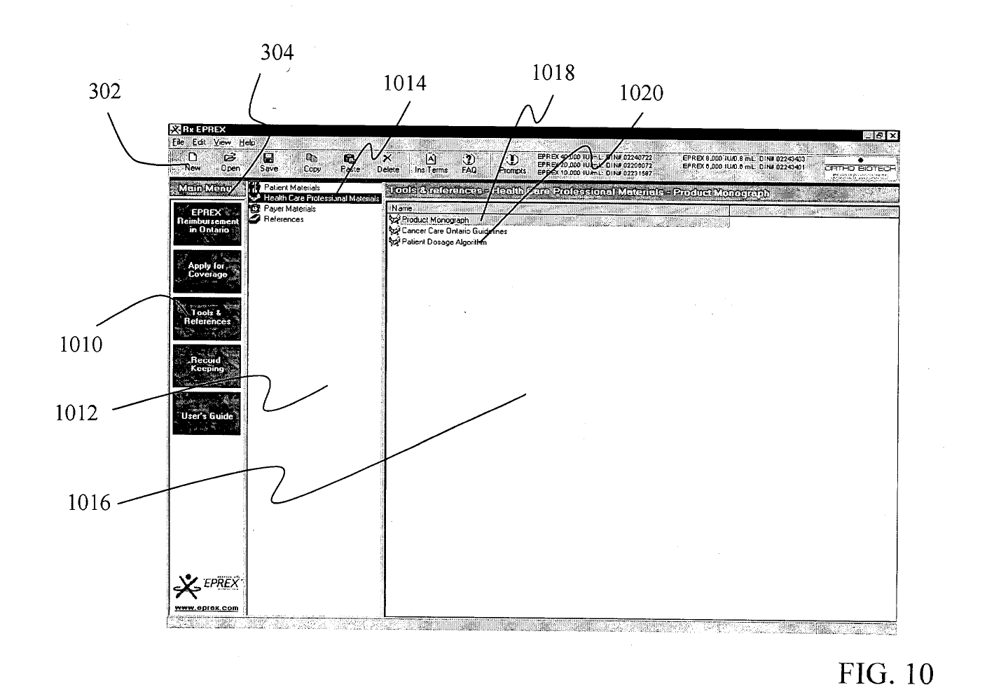

Referring to FIG. 3, Drug Benefits screen 300, a user interface, is generated by software system 100. Drug Benefits screen 300 comprises four regions: tool bar 302 on top and three vertical panels beneath it, namely, main menu 304, quick view panel 306, and reimbursement panel 308. While the particular orientation and layout of the display element is not essential, the display elements should be arranged in a manner that is relatively easy to use. Tool bar 302 provides access to operational controls of the software system. It also provides access to information stored with the software system (to be described in more detail later). Main menu 304 provides a number of activatable “buttons” for accessing different modules of the software application. Main menu 304 also provides access to further reference information stored locally with the software system and information accessible remotely, as will be described in more detail later. Functional modules accessible by these “buttons” will be described here and later with reference to FIGS. 10 to 12. Both tool bar 302 and main menu 304 generally remain unchanged while the other two regions, quick view panel 306 and reimbursement panel 308, may be replaced by other panels depending on which functional module of software system 100 is active.

Quick view panel 306 provides access to information specific to individual insurance providers. This is also the panel displayed when “EPREX Reimbursement in Ontario” button 310 is clicked. Quick view panel 306 displays a “tree-view” of insurance providers. A “tree view” is a list that can be expanded or collapsed by clicking on “+” (expand) or “−” (collapse) symbols. While a tree view is preferred, some other convenient display and selection arrangement may be used. In general, insurance providers may be divided into three broad categories: private insurance, provincial insurance, and federal insurance, as they may have different rules and procedures for submitting reimbursement claims. While the arrangement may be customised differently, quick view panel 306 displays a “tree-view” having three “branches”, each branch corresponding to one of these three categories. To view more detailed information about an insurance provider, a user may select that particular insurance provider in an expanded view. In an expanded view, the software system displays detailed information about that insurance provider in reimbursement panel 308.

Such detailed information specific to insurance providers may include contact information and benefit policies relating to certain special purpose drugs. The specific information may be provided either by the software system or entered by the user of the software. Other information related to insurance providers may be accessible from tabs “Who is Eligible”, “Claims Process”, and “Coordination of Benefits”, which will be described in more detail below.

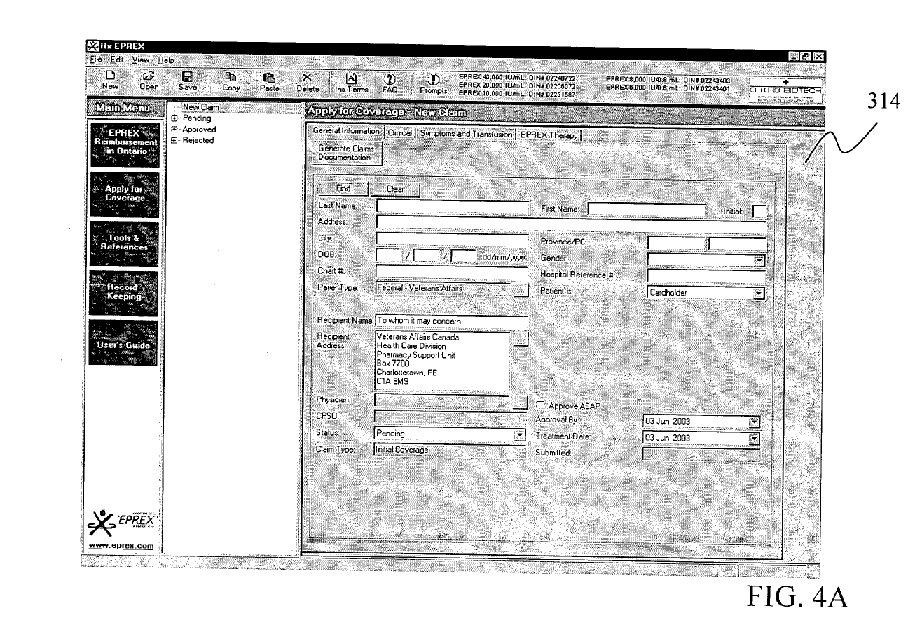

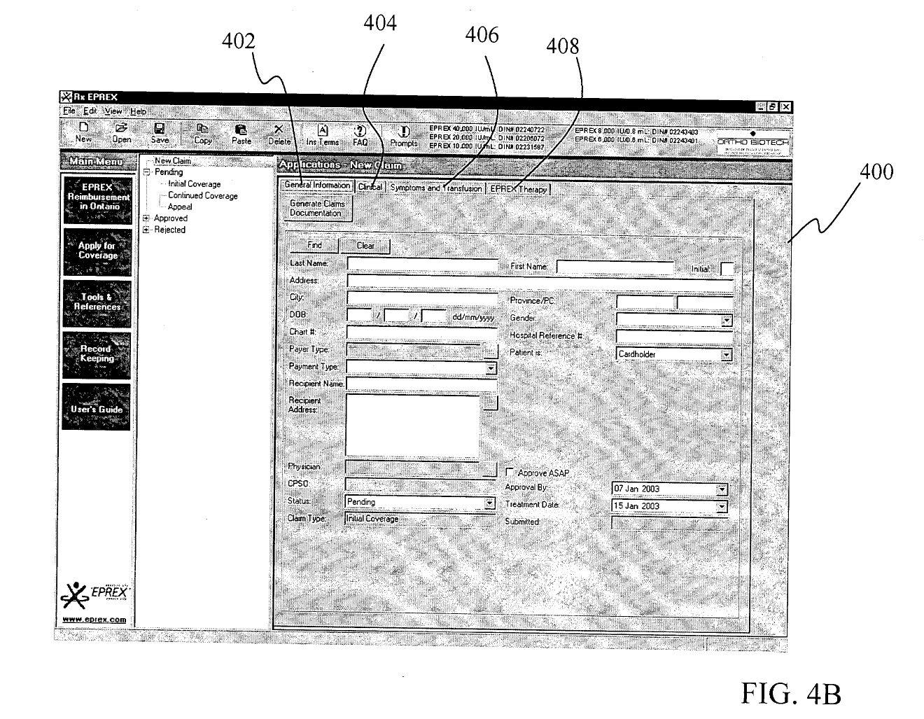

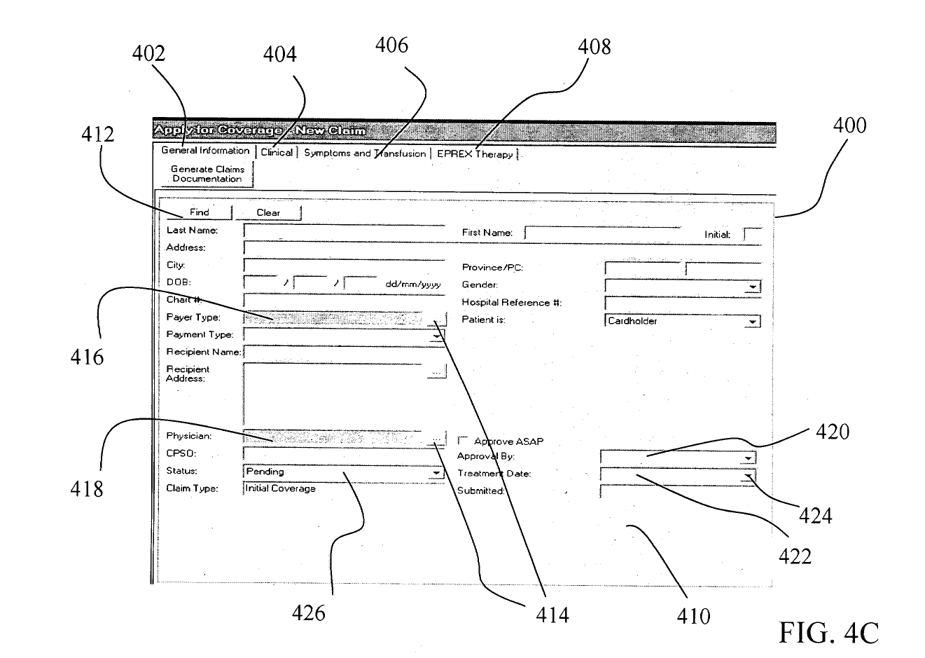

To initiate a claim, a user selects Apply for Coverage button 312 in reimbursement panel 308. Thereafter, Apply for Coverage panel 314 is displayed and replaces reimbursement panel 308 (FIG. 4A). Software system 100 allows a user to retrieve information specific to the insurance provider from database 120 and automatically enter the information into relevant fields of the data entry form. FIG. 4A provides an example of such a partially completed input screen. Alternatively, a user may select Apply for Coverage button 312 from main menu 304. A blank data entry form 400 is displayed and replaces reimbursement panel 308 (FIG. 4B). The software system provides access to its data entry function and database retrieval function through these input screens, described in more detail below.

To complete a claim form or for generating further supporting letters on behalf of a patient, a physician enters both general patient information pertinent to the claim form and medical prescribing information relating to treatment of the patient. To facilitate the physician's preparation of claim documentation, data entry form 400 provides four tabs: General Information tab 402, Clinical tab 404, Symptoms and Transfusion tab 406, and EPREX Therapy tab 408.

FIG. 4C shows blank data entry form 400, or General Information screen 410, that is displayed when General Information tab 402 is clicked. This screen is for entering general information about patients, physicians, and insurance providers (or “payers”). General information about patients includes name, residence information, date of birth (“DOB”) and gender. The software system may update the input screen so that a user may enter additional information depending on age (or DOB) or residence, for example, information applicable only to seniors or minors; the system may also process the claim forms differently based on the patient's general information provided, for example, DOB or residence.

Information required by this screen may be entered manually. Such is often the case where a new patient or new insurance provider is involved. Integration of database 120 with the software system permits the retrieval and reuse of patient information stored in database 120, thus reducing the needs of repetitively entering in the same data and the opportunities of introducing clerical errors. Information of existing patients may be retrieved from database 120, and is accessed by activating the “find” button 412. Thereafter, a list of existing patients is displayed. Once a patient is selected from the list, the system populates the data entry form 400 automatically. Software system 100 may also be configured to obtain patient and other data from an external data source, such as the health care provider's own database (not shown).

Similarly, insurance provider (payer) information and physician information may be entered directly, or retrieved from database 120 by using “Look-up” buttons 414 located beside payer type field 416 and physician field 418, respectively. Once a payer type is selected, the software system automatically enters the data into relevant fields of the data entry form (General Information screen 410). As in the case of patient-related information, data entry module 110 also examines data entered here and updates General Information screen 410 to reflect any additional specific information that is required by a particular insurance provider when submitting a claim. Information specific to an insurance provider may include the name of the policyholder, group policy/plan number, division number and certificate number. This automated data entry and data validation may help simplify various administrative tasks related to preparing claim documentation, and may help maintain the consistency and accuracy of completed claim forms.

A user may also set Approval By date 420 and Treatment Date 422, according to when the user is seeking pre-approval of the claim and when the treatment is to start. To set the date, a user may click on drop-down button 424 next to, for example, Treatment Date 422 field. A scrollable calendar will be displayed, through which a treatment date may be selected.

Status field 426 displays the status of a claim. This field may be one of “pending”, “approved”, and “rejected”, to reflect the status of the claim in its life cycle. When creating a claim, the software system initially sets this field to “pending”. For existing claims, this field may be changed to “approved” or “rejected” by the user. As will be described in greater detail later, this field is used to access status tracking module 140 for recording and updating a claim's status. Updating recorded status also triggers other management functions of status tracking module 140. A user of the software system, typically a health care professional or a physician, will need to re-visit this screen to change the status of a claim upon being advised of a decision by the insurance provider with respect to the claim.

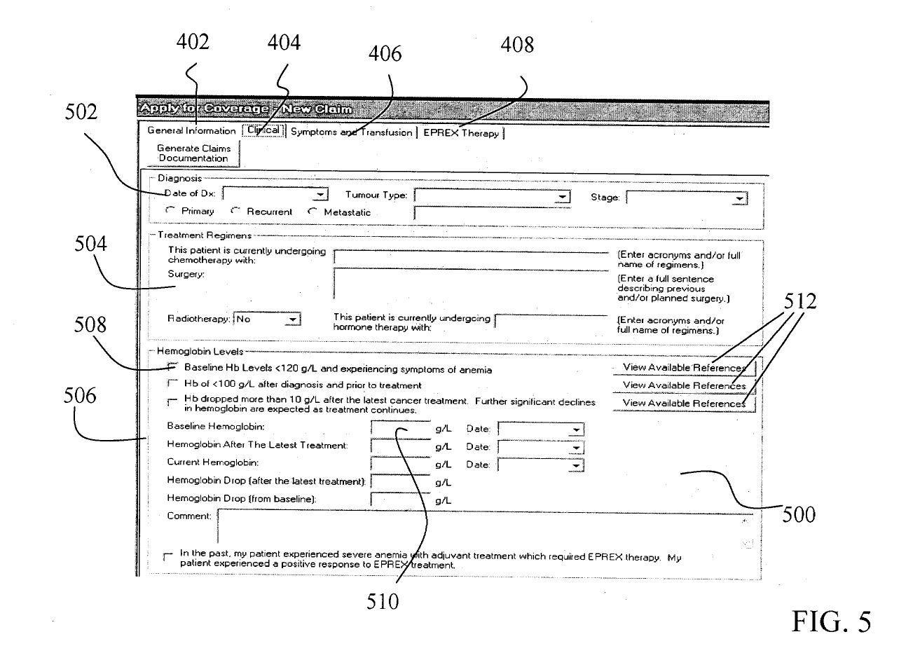

Reference is now made to FIGS. 5 to 7. The software system provides input screens for physicians to enter medical information about their patients. For enhanced efficiency in preparing claim forms, these input forms may have standard entries, or entries most relevant or most often required for a particular illness or treatment. These input forms may also have areas, or windows, that permit entry of personalized notes or instructions of physicians to provide physicians with greater flexibility and convenience in completing these forms.

Referring to FIG. 5, Clinical tab 404 provides access to Clinical screen 500. Clinical screen 500 is used for entering clinical information that is relevant to a claim submission. Three different sections are provided: Diagnosis section 502, Treatment Regimes section 504 and Hemoglobin Levels section 506. A physician's diagnosis of a patient may be entered through Diagnosis section 502. A patient's current treatment regimens may be entered through Treatment Regimens section 504 including acronyms and/or full name of regimens with which the patient is currently undergoing (e.g., chemotherapy). The physician may also enter a description of previous and/or planned surgery for the patient. In this particular example of software system 100, Hemoglobin (Hb) Levels section 506 permits the physician to enter the diagnosis of anemia by checking one of the three boxes provided on this screen. The software system determines information required and validates the consistency of data entered. For example, when Baseline box 508 is checked, indicating a baseline Hb level of less than 120 g/L and that the patient is experiencing symptoms of anaemia, the physician also needs to fill in Baseline Hemoglobin box 510 to indicate a baseline hemoglobin value of between 0 and 119. In all three sections, the software system provides selectable entries from drop-down buttons and checkboxes for standard entries and comment windows for entering free form text, or personalised comments or instructions of the physician. From Clinical screen 500, the physician may also access reference information applicable to the patient's medical conditions through “View Available References” button 512, which function and purposes will be described in greater detail later.

Clinical screen 500 is merely one example input screen. As noted earlier, software system 100 could also be used for other ailments and treatments. For any particular disease or ailment, Clinical screen 500 (and symptoms screen 600 described below) may be configured differently for entering clinical information most relevant to that disease or ailment, in which case the content of the screens described herein would be different. By providing these standard, or most relevant, entries, the software system assists with efficient creation of claim forms for cancer patients. The reference information provided, as relevant to a particular ailment or treatment, will also be different when the software system is adapted for handling medical insurance claims relating to other ailment or treatments. For example, input screen 500 for entering clinical information may be tailored for treatments for HIV/AIDS symptoms, in which case standard entries for diagnosis and treatment regimes may be substantially different from the input screen shown in FIG. 5. FIG. 5A shows an exemplary input screen for entering clinical information relevant to an HIV/AIDS patient. It will be appreciated that in other embodiments reimbursement for the use of other drugs in the treatment of various ailments and diseases may be facilitated in respect of the claim forms and other requirements of various insurance providers.

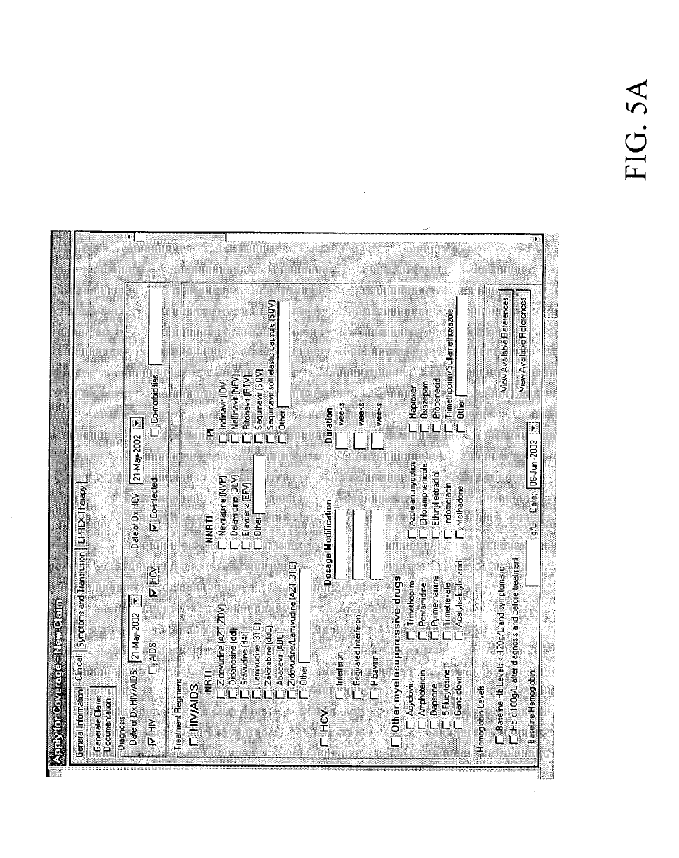

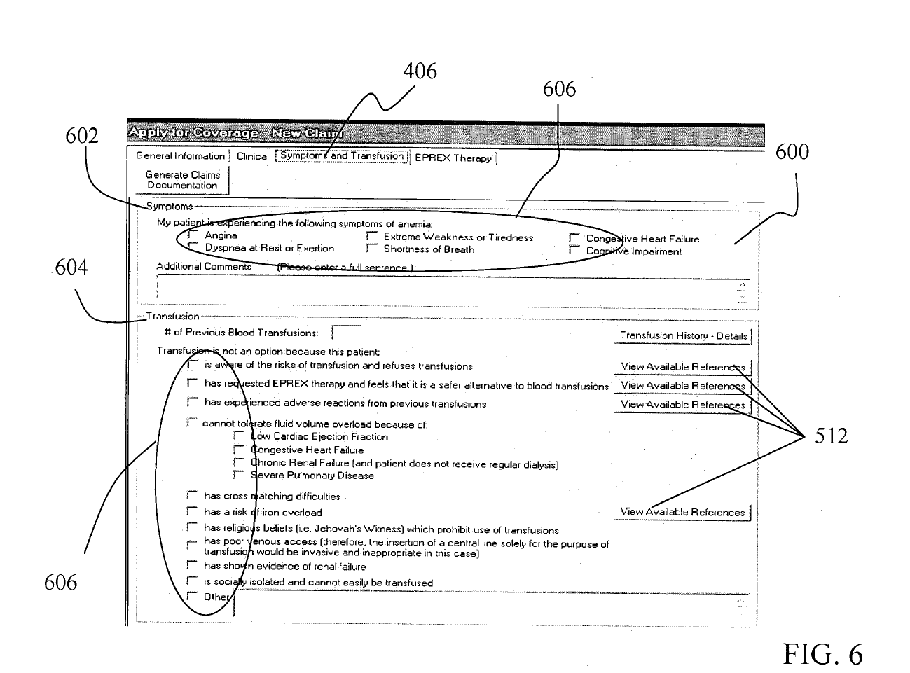

Referring to FIG. 6, “Symptoms and Transfusion” tab 406 provides access to Symptoms and Transfusion screen 600. Symptoms and Transfusion screen 600 provides an input form for medical information that is relevant to claim submission for the treatment regime of this example. This screen has two sections: Symptoms section 602 and Transfusion section 604. A physician may enter symptom information in Symptoms section 602 by selecting available symptoms or transfusion checkboxes 606, or enter any relevant personalized comments in “Additional Comments” field provided in this section. The number of previous transfusions and any relevant transfusion details may be entered in Transfusion section 604. The physician may also select from a list of frequently cited reasons why a transfusion is not an option, to justify, for example, an alternative therapy. As in Clinical screen 500, “View Available References” buttons 512 are available here as well.

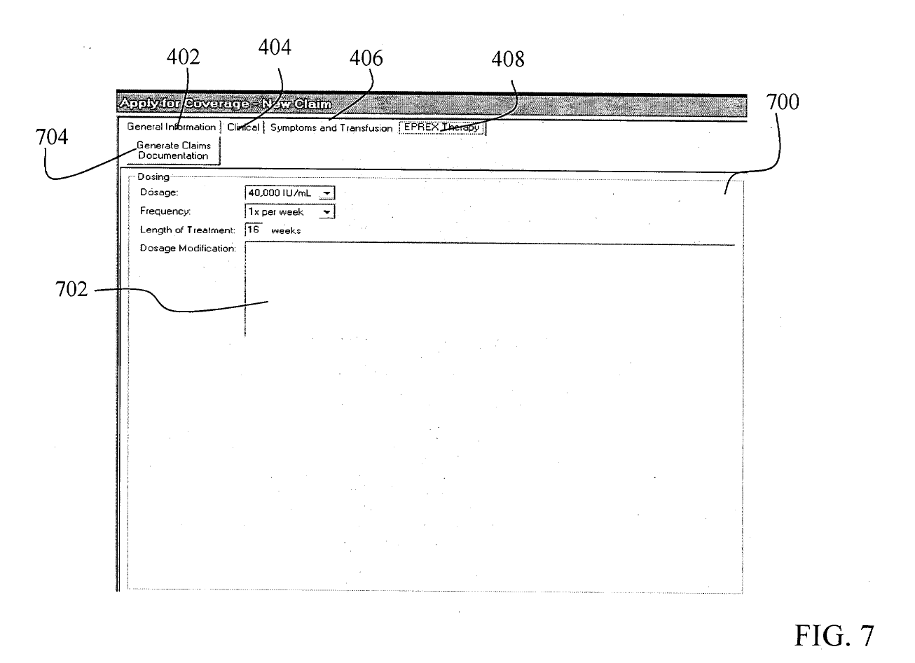

Referring to FIG. 7, EPREX Therapy tab 408 provides access to EPREX Therapy screen 700. (Eprex is the therapy applied in this particular example.) A physician enters information here related to EPREX therapy. Such information includes dosage, frequency and length of treatment. Drop-down buttons provide a list of pre-selected values for standard dosage and frequency. However, the physician may modify the standard dosage by providing instructions in Dosage Modification window 702.

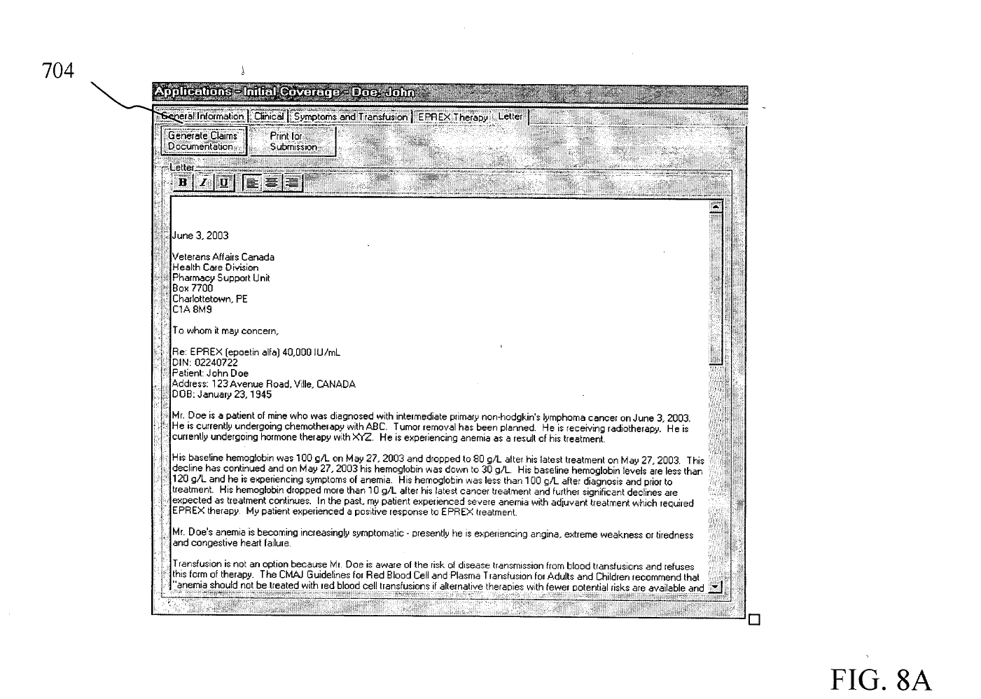

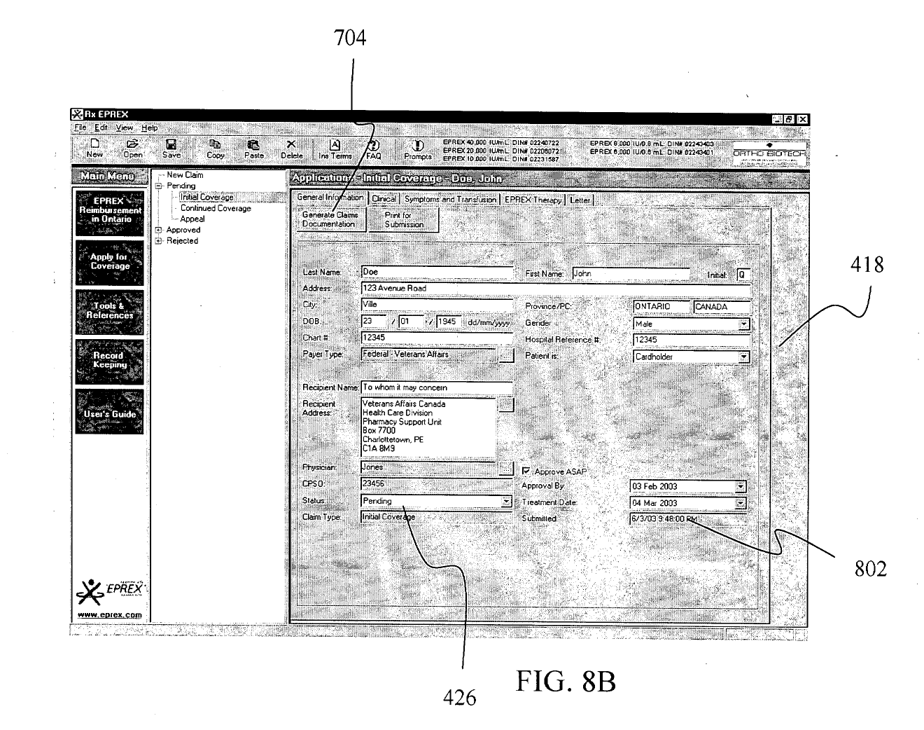

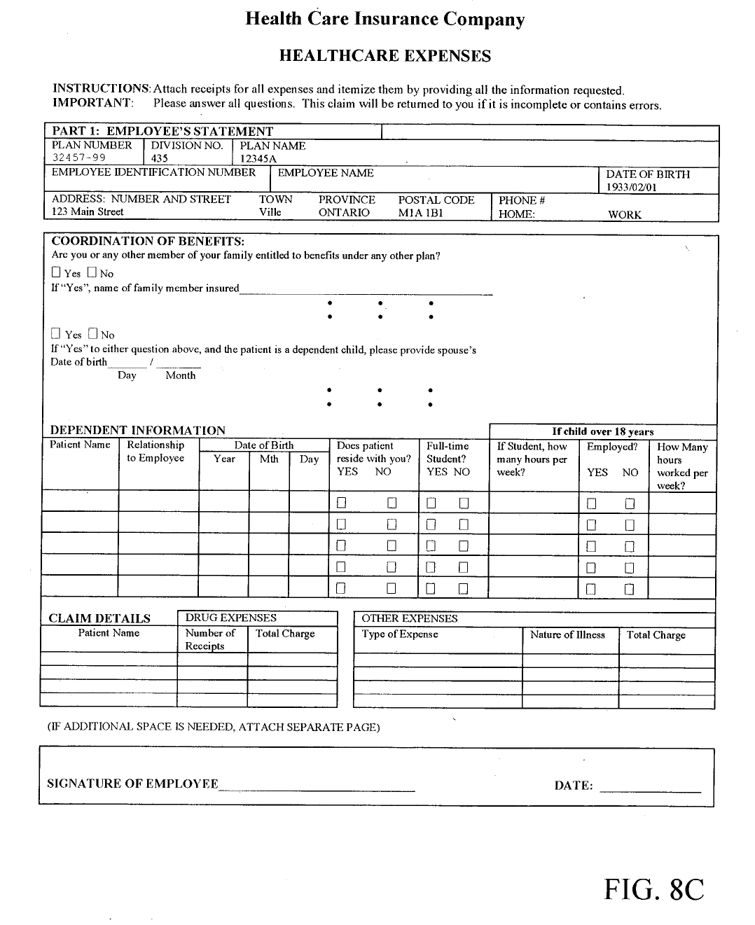

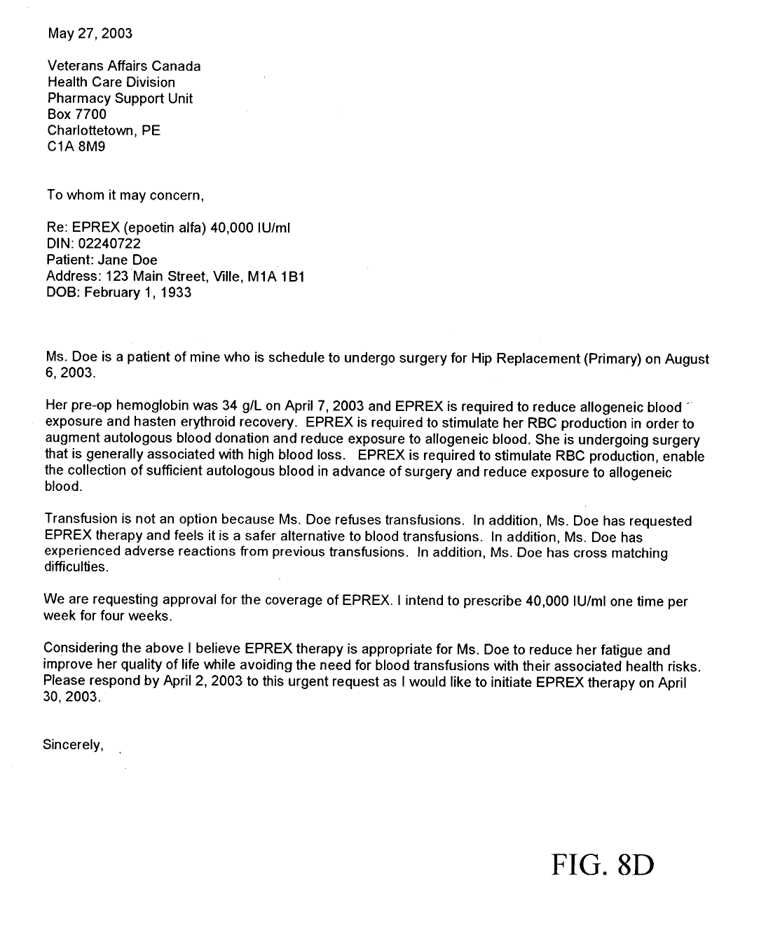

Once all information is entered, the software system generates the claim documentation for submission to the selected insurance provider. The claim generation module 130 is accessed through “Generate Claims Documentation” button 704. As insurance claim forms for different insurance providers typically have different formats and each insurance provider may prefer to process insurance claim forms having a format identical to its standard form, the software system generates claims forms conforming to the format adopted by the insurance provider in question. This may expedite the processing of insurance claims by insurance providers. The physician may choose to generate a claim form alone. FIG. 8C shows a claim form typical of the forms generated and printed by the software system. Where necessary, a covering letter to the insurance provider may also be generated. The letter generated by the computer system and shown in FIG. 8A may be revised online by the physician before it is printed for submission. FIG. 8D shows a letter typical of the letters generated and printed by the software system.

Once the software system prints the claim form and the letter for submission, the system automatically records the printing time as submission date 802 associated with the new claim (FIG. 8B). The claim with this submission date is then tracked by status tracking module 140 of the software system during the life cycle of the claim. If the patient is new, i.e., if database 120 does not have an entry for the patient, information entered when preparing the claim is automatically added to database 120 when “Generate Claims Documentation” button 704 is activated. Similarly, the software system will add physician and insurance provider information to database 120 if no information about the physician or the insurance provider exists in database 120.

The physician may need to include reference materials to justify a treatment. This may be the case where pre-approval or reimbursement of a non-standard treatment is sought. This may also be the case where appeal of a denied claim is made. Reference information applicable to a patient's medical condition and the therapy prescribed may include medical references and legal references. They are typically references to research by third party researchers (e.g., journal articles) and other information and stored with the software system, which otherwise may not be readily accessible. The software system provides access to its reference collection 150 through “View Available References” buttons 512 (FIGS. 5 and 6). When clicked, a list of available and applicable references is displayed, from which a physician may select suitable ones for incorporation into claim documentation, for example, a supporting letter. The software system 100 may also be configured to provide a copy of the actual reference cited. Such reference may be stored electronically either as part of software system 100 or retrieved from an external source such as the Internet.

These reference materials may also be used as an information tool and help physicians in the assessment of the patient. For example, the references may help physicians to choose clinical indicators of a patient's medical conditions. This may help the physician to assess the patient's medical conditions and thus diagnose the patient.

Medical reference information may include guidelines recommended by specialized medical associations or pharmaceutical associations for treating patients' illnesses diagnosed by physicians. It may also include reference information and research reports published in specialized medical journals. Reported results of research or experiments conducted with patients in similar situations where no standard treatment has been developed may also be provided.

In this particular example, for a patient with cancer and anemia, there may be several clinical references available to support use of a particular therapy. The physician may include passages from these references directly in letters accompanying claim forms. As many references as are available may be included in a letter. Certain tumour types may have additional relevant references. The software system may add these references automatically to the end of the claim letter where at least one of these tumour types has been indicated in Clinical screen 500. These tumour types may include, for example: breast tumour, multiple myeloma cancer, small-cell lung cancer, lung-small-cell lung cancer and myelodysplastic syndrome. Users may also enter their own references into the software system 100.

The reference information may also include references to legal issues dealing with duties of a physician to provide alternative treatments where certain standard medical treatments are not available, either because of the patient's clinical condition or because of the patient's refusal to accept the standard treatments. Further information or references to further information may be provided to inform physicians of situations where these rules may apply and where further legal assistance may be necessary.

While the software system provides for the covering letter standard paragraphs or sentences, they may be edited. When a particular piece of reference information is selected and included in the physician's letter. The letter is electronically saved for later reference and reuse.

The software system tracks the status of a claim from its initial submission to its final approval or rejection, and facilitates the management of the tracking of claim status. This function is provided by its status tracking module 140. All claims, whether newly created, approved, rejected or still under appeal, are stored electronically by the software system. Whether they are stored as individual records or in linked tables, each claim has a field indicating its status in its life cycle. Status tracking module 140 uses this field to track and manage claim status. It also produces summary or statistics reports based on the value of this field and the creation date associated with the field. As a first feature, the software system records the time of printing claim forms and supporting letters as submission date 802 of the initial claim.

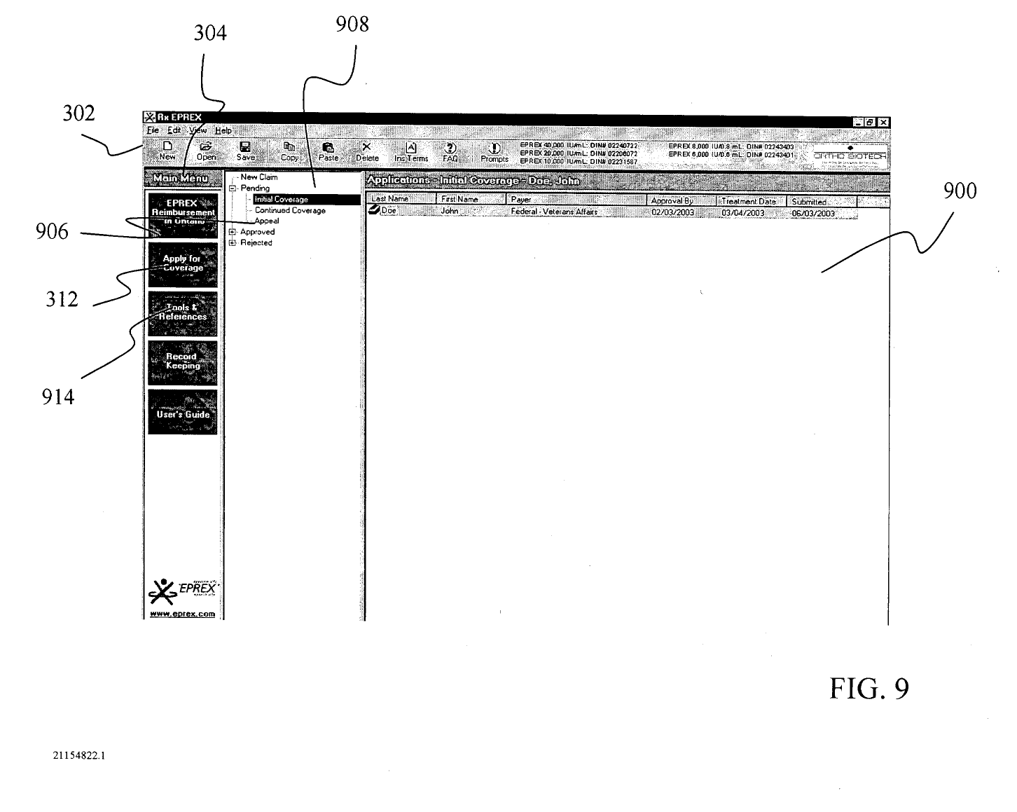

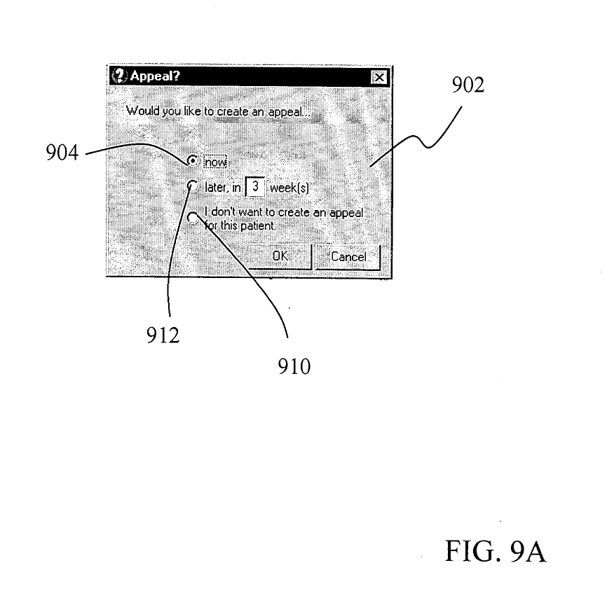

To access the status of a claim, a user may click on Apply for Coverage button 312 of main menu 304. A “tree-view” of pending, approved, and rejected claims is displayed in the middle vertical panel 908 shown in FIG. 9. By expanding the view on pending claims and then select “initial coverage”, for example, a list of submitted new claims is displayed in “Initial Coverage” panel 900 (FIG. 9). Selecting a particular entry brings up a General Information screen 410, similar to that when data for new claim form is entered (see FIG. 8B). Through this screen, a user changes the recorded status of a claim by changing the value of status field 426 and thereby tracks and manages claim status of a claim associated with any particular patient.

As described above, status field 426 provides three selectable values: “pending”, “rejected” and “approved”. Upon being advised of a decision by the insurance provider with respect to the claim, the health care professional may change the value of the status from “pending” to either “rejected” or “approved” accordingly.

Upon being advised of the rejection of a pending claim, a user changes the claim's status from “pending” to “rejected”. The user may decide to appeal the rejection (step 56) or decide not to appeal and record the final status of the claim as “rejected” (step 58). The software system displays a pop-up appeal dialogue box 902 as soon as the status of a claim is changed from “pending” to “rejected” (see FIG. 9A). Through dialogue box 902, the user is provided the opportunities of recording the decision to appeal or not to appeal, or of postponing such a decision. To create appeal documentation now, the health care professional selects option Now 904. The software system notes the existing, pending claim as being rejected and displays it in the “rejected” section. Software system 100 creates a new appeal claim, which includes some of the information from the old (initial coverage) claim. This new claim is now saved as a Pending-Appeal claim 906 (see FIG. 9). As noted before, to have the appeal granted, it may be necessary to include further reference information in a supporting letter. The physician may also need to identify additional reasons for the treatment. Input screens similar to those shown in FIGS. 5 and 6 are provided for physicians to identify these reasons and include these references in appeal documentation. Clicking on “Generate Claims Documentation” button 704 causes the software system, or its documentation generation module 130, to generate all of the necessary letters and/or documents for submission to the insurance provider for the appeal. The completed claim forms and/or letters may be saved for later reference or reuse. Submission date of appeal documentation is also automatically set to its printing date and entered into the system. To view a summary of all current appeals, a user may select, for example, Pending-Appeal claim 906 in the middle vertical panel 908 shown in FIG. 9.

The physician may also decide not to appeal the insurance provider's rejection. To do so, the physician may select the appropriate “No Appeal” option 910 in appeal dialogue box 902, in which case the system records the final status of the claim as “rejected” and displays the rejected claim in the “rejected” section in middle vertical panel 908.

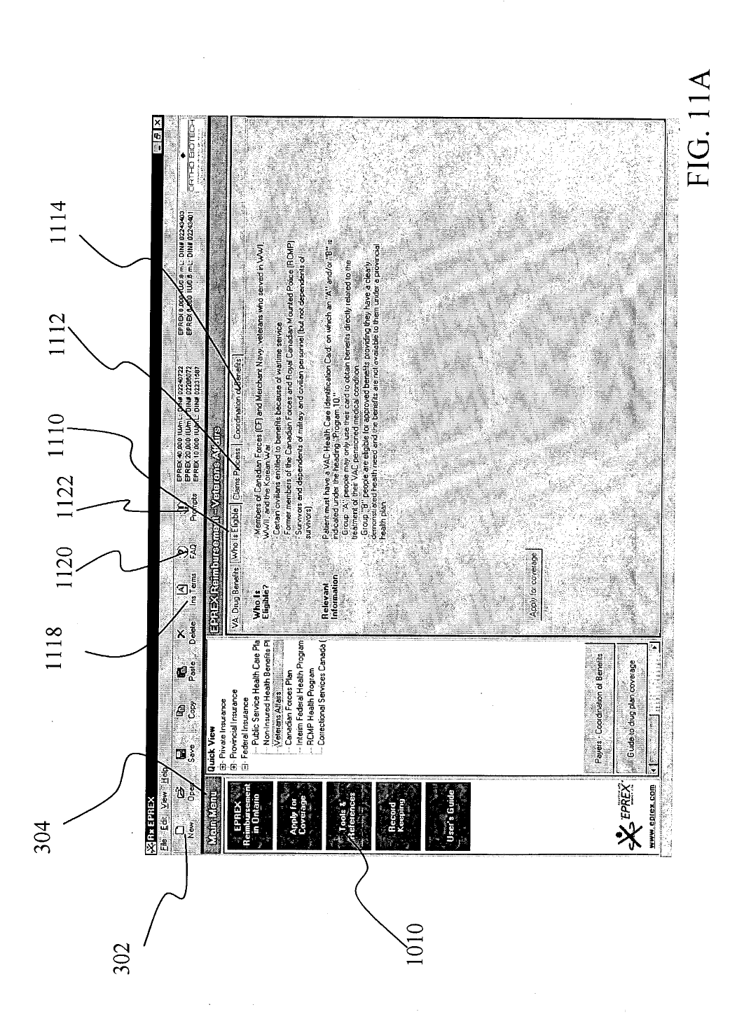

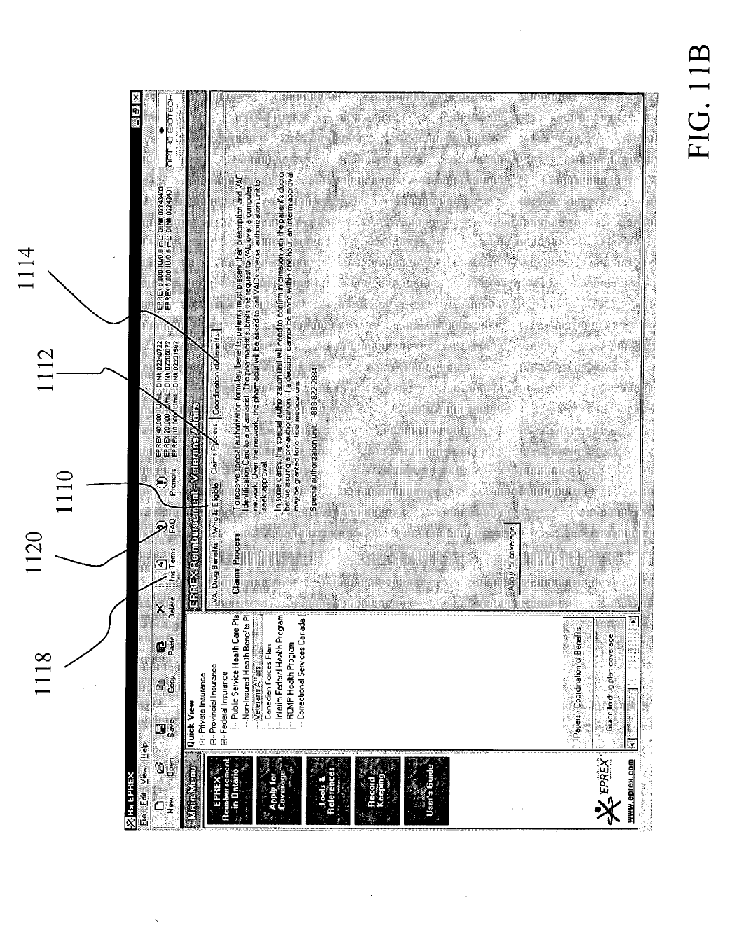

If the physician decides to postpone the decision as to whether to appeal the rejection until, for example, three weeks later, the Postpone option 912 is selected. When this option is selected, the software system calculates an earliest due date when the appeal documentation should be created. As soon as the user uses the software system on or after this due date, the software system will generate a message reminding the user about pending appeals. At that time, the physician may decide to create appeal documentation for submission. Alternatively, a user may also click “Prompts” button 1122 on tool bar 302 (FIG. 11A) to display a summary of claims that require a decision on whether to appeal.

Upon being advised of the approval of a pending claim, a user may change this claim's status from “pending” to “approved”. The software system notes the claim as “approved” and displays it in the “approved” section. Additionally, the software system may prompt the user to determine whether a request for continued coverage should be created. If so, a timeframe for the continued coverage (for example, 90 days) may be entered into the system. The software system will generate a reminder regarding continued coverage request in 90 days from the current date or as soon as the system is used thereafter. When “Prompts” button 1122 is clicked, summary of claims displayed may also include such requests.

If a new continued coverage request is created, the request typically includes some of the information from the initial coverage claim. This new claim may be saved as a Pending-Continued coverage request. Some information applicable to the new claim, for example, treatment dates or dosage, may be required. Some individual insurance providers may also require other special information relating to a continued coverage request which must also be entered. Continued coverage request forms and any supporting letter, where required, may be similarly printed for submission.

The software system program provides access to reference materials for health care professionals to facilitate claim process and management tasks. Reference is made to FIG. 10. To access these reference materials, a user clicks Tools & References button 1010 from main menu 304. A list of categories of reference materials relating to patients, health care professionals, insurance providers, and general references is displayed in Tools & Reference panel 1016. A user, such as a health care professional, may select “Health Care Professional Materials” 1014, in response to which the software system displays a list of references in Tools & Reference panel 1016. “Product Monograph” 1018 or “Patient Dosage Algorithm” 1020, for example, may then be selected for further study or reference. Also accessible are references stored with the software system or materials accessible only remotely, for example, over the Internet. A user may also select “Patient Materials” to gain access to reference materials provided by the system on, for example, assessing a patient's clinical or medical condition. Or a user may select “Payer Materials” to gain access to reference materials included with the system and supplied by insurance providers, such as individual providers' brochures or standard claim forms. Selecting “References” in reference panel 1012 provides access to these materials in a similar manner. Once a list of such materials or a particular piece of such materials has been displayed, the software system allows physicians' updating of the reference materials stored with the software system, downloading to their local workstation additional reference materials, and modification of the reference materials stored locally.

To further facilitate claim submission and management tasks, the software system provides access to information specific to insurance providers. For example, Drug Benefits screen 300 (FIG. 3) displays information relating to specific drug benefit policies offered by a particular insurance provider. Clicking on Who is Eligible tab 1110 brings up an information screen, which provides brief information on eligibility standards for a special purpose drug under the insurance plan (FIG. 11A). Likewise, clicking Claims Process tab 1112 brings up a screen showing information relating to the specific insurance provider's claims process (FIG. 11B). Similarly, when Coordination of Benefits tab 1114 is clicked, information relating to coordinating benefits between, for example, spouse and family members' insurance plans are displayed (FIG. 11C). The software system also provides further information by means of pop-up windows. For example, when a pointing device, such as a mouse, is moved to point to a highlighted special term, “coordination of benefits”, a pop-up information window, such as “Coordination of Benefits” window 1116, is displayed providing further explanation of the term “coordination of benefits”. These types of information may be likewise modified, updated or added.

Furthermore, general information is provided through activating buttons on tool bar 302. For example, when “Ins Terms” button 1118 is clicked, a window displaying a glossary of terms used in the insurance industry is created. Further, a button such as FAQ button 1120 may be provided on tool bar 302. Clicking on this button generates a window displaying a list of frequently asked questions and their answers. Similar to information accessible through Tools & References button 1010, information accessible through buttons located on tool bar 302 may also be modified, revised, or added.

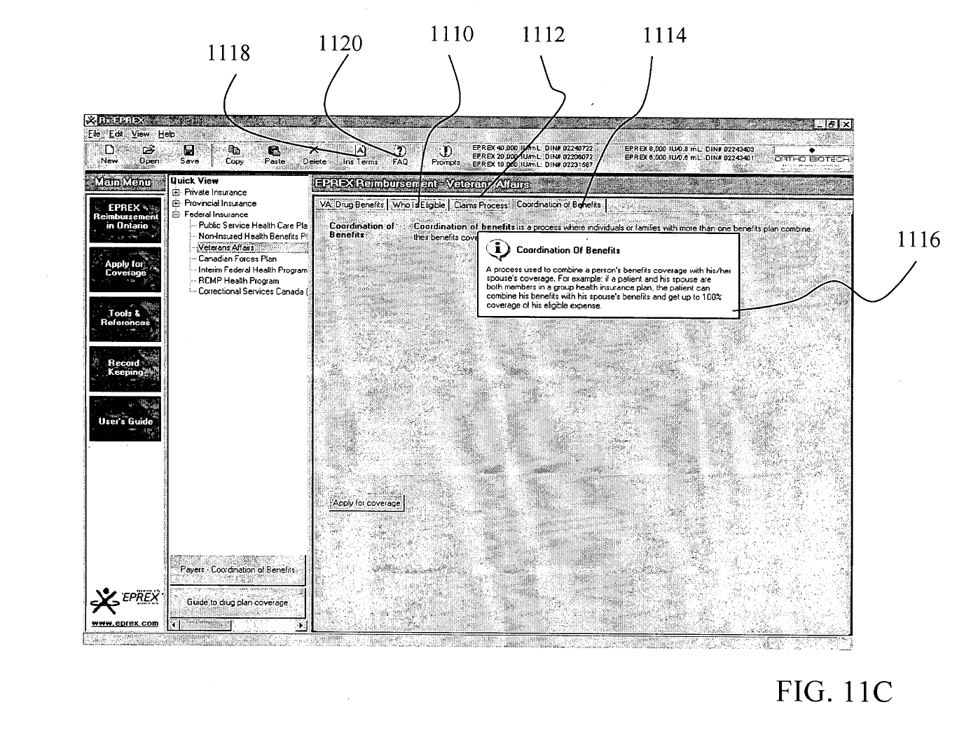

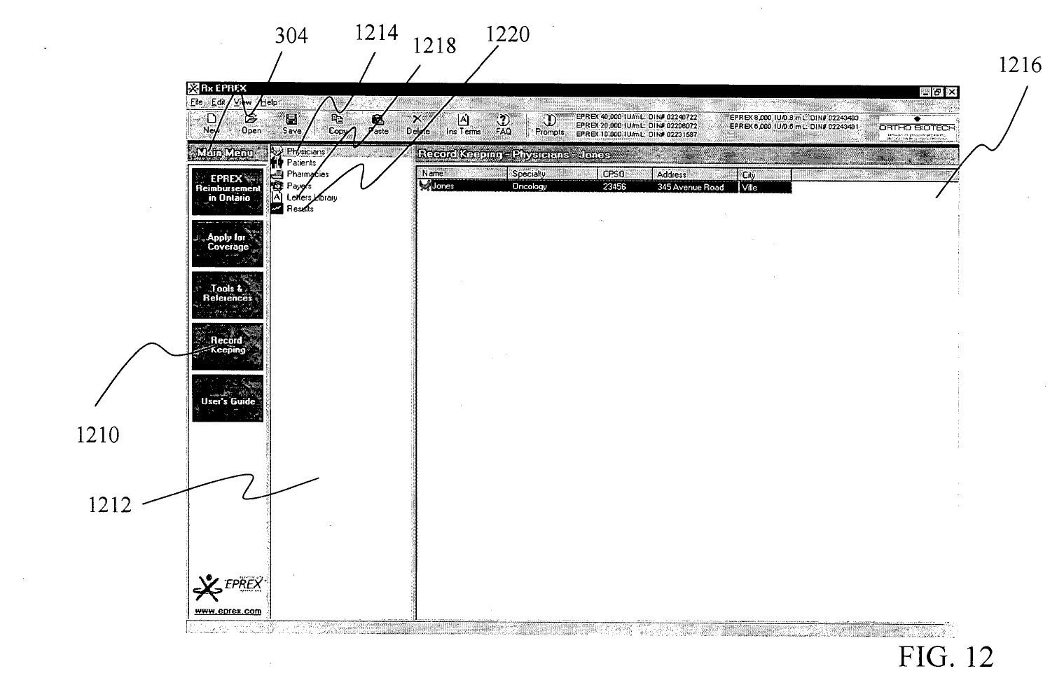

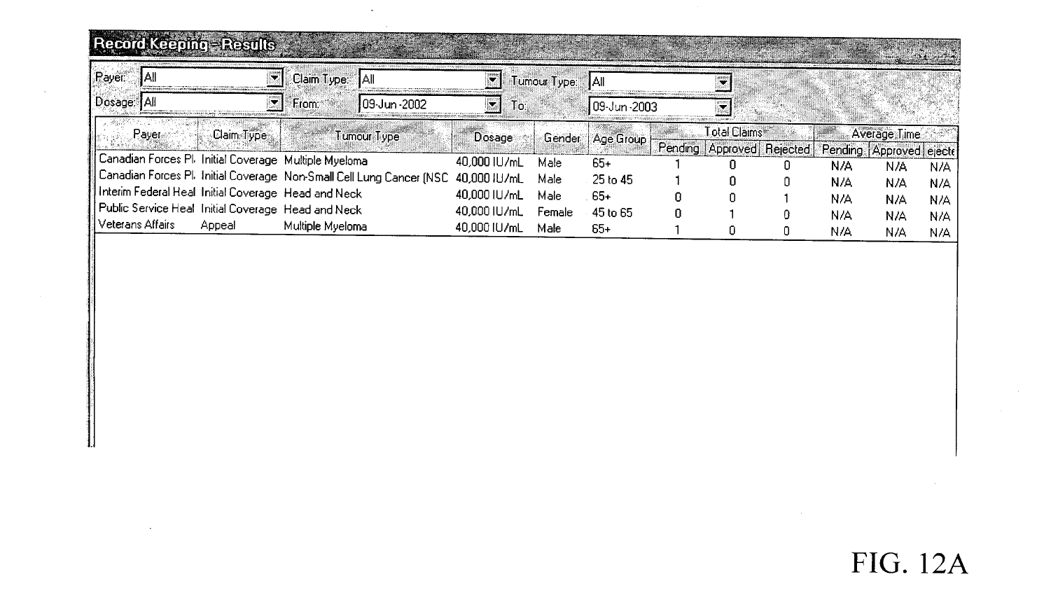

A user may need to access databases of patients, physicians, pharmacy and insurance provider information while not creating any claim forms. The user may also need to access a library of letters generated and the results of claim submissions. More generally, the user may need housekeeping ability with respect to data stored with the software system. Referring to FIG. 12, the software system provides access to the “Record Keeping” function from main menu 304 through Record Keeping button 1210. Clicking Record Keeping button 1210 in main menu 304 displays selectable lists of physician information, patient information, pharmacy information, payer (or insurance provider) information, letters library, results and reports in record list panel 1212. A user may access data stored in database 120 by selecting an entry from the selectable lists.

For example, if a user selects “Physician” 1214 from the selectable lists, a list of physicians stored in database 120 is displayed in Physicians panel 1216. The software system permits users to sort the list of physicians by name or speciality or other ranking criteria. A user may review the details of a physician by, for example, highlighting and selecting the physician's entry in the list. Once a physician's detailed information is displayed, the information can be revised, updated and saved. Once saved, the new information will be reflected in all claim forms generated thereafter. Similarly, selecting “Patients” from the selectable lists causes the system to retrieve patient data from database 120 and displays a list of patients. Details of a patient's record or claims may be reviewed by selecting the patient from the list. A summary of claim status relating to that patient may also be displayed. Information about pharmacies or insurance providers may also be reviewed or revised similarly by selecting “Pharmacies” or “Payers” from the selectable lists, respectively. If “Letters Library” list 1218 is selected, a list of letters stored with the software system will be displayed. The list is sorted by tumour type, insurance provider or patient. To review in detail any letter, a user highlights the entry corresponding to the letter and select Open on tool bar 302. Thus, any letter generated in the past for submission, either to seek pre-approval of a treatment or to appeal a rejection of a claim, may be reviewed or reused as needed. If “User's Guide” is selected from main menu 304, a copy of user documentation is displayed, explaining in detail how the software system 100 is used.

The software system provides reporting function. If a user selects “Results” list 1220 from the selectable lists, a summary report is displayed and maybe printed or uploaded to a central database (FIG. 12A). The summary report includes statistical data such as total number of claims submitted by a user in each of pending, approved and rejected categories. Average time, i.e., average number of days, for each category of claims to be processed is also included. Details concerning a particular payer, the type of coverage, or any other data collected may also be provided. The report may, for example, group the results by different criteria such as claim type, treatment type, dosage, insurance provider, or the beginning or end of a time period. Patient related data may also be reported. For example, data illustrating a summary of patients by criteria such as patient gender, patient age, and patient tumour type may be generated by the software system 100.

Databases of the software system store information concerning the status of all claims. By storing and reusing data stored in these databases, the software system assists managing medical insurance claims which include patients' medical information. Such an integrated software system also provides the possibility of collecting statistical data about a particular treatment of certain medical conditions. For example, locally stored patient information may be collected from physicians' local workstations (preferably after removing personal information about patients) and stored in a central database. Such statistical data may be used for analysing the effectiveness of a particular treatment prescribed by different physicians for their patients of similar medical conditions. Pharmaceutical companies may be interested in such information relating to the effectiveness of their products in treating patients. Research reports generated by researchers using the patient information retrieved from the central database may also be fed back to the central database for downloading by physicians to their local workstations. Physicians may cite such information in support of or for justifying treatments prescribed for their patients in the future.

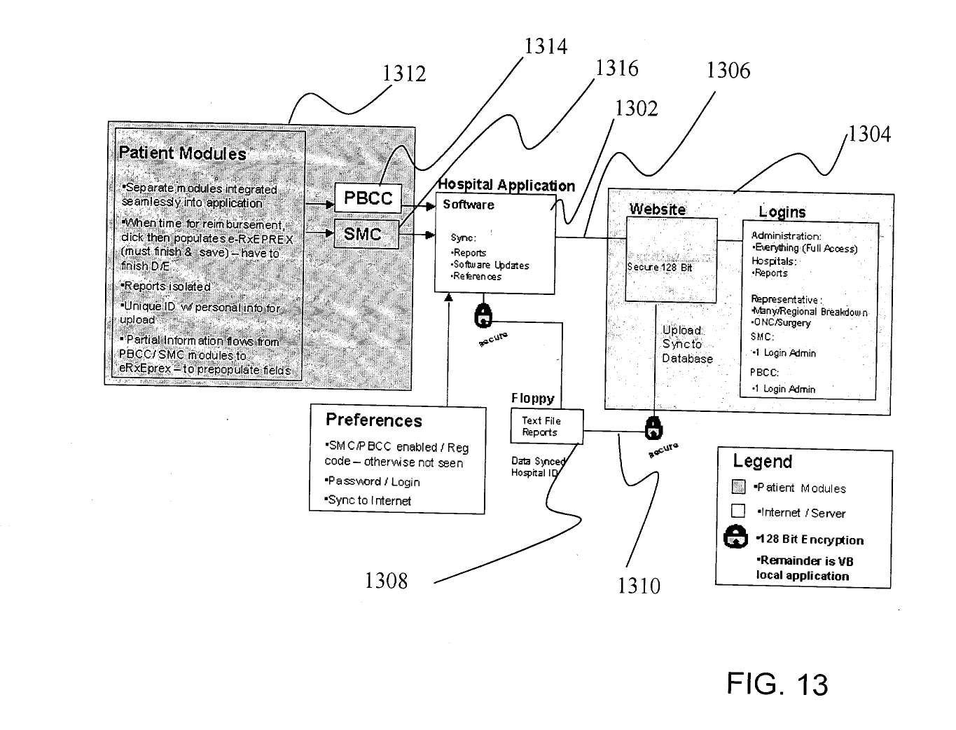

Shown in FIG. 13 is an alternative embodiment of a computer software system for tracking and managing insurance claims on behalf of patients. The computer software system has a portion, hospital application 1302, that may be hosted on a computer located in a hospital or elsewhere. The software system shown is web-enabled. It provides a web site 1304 that may be accessed by physicians over Internet connection 1306 or some other telecommunication means, either through transmission wires or wirelessly. Physicians may access web site 1304 remotely in their own offices to complete tasks such as data entry, status tracking or documentation generation. Text file reports 1308 may be generated locally in a physician's office or transmitted through secure transmission lines 1310 connected to hospital application 1302. The computer software system is interfaced with patient assessment tools modules 1312, to provide further integration of patient information with the software system, in particular its database 120. Patient assessment tools may include surgery assessment tools or oncology assessment tools. Examples of such patient assessment tools modules include PBCC 1314 and SMC 1316, which may be used by healthcare providers, such as physicians and nurses, to record and assess patients' medical conditions and to keep records of medical treatments administered on patients. This information may then be integrated with information used for the insurance reimbursement process. This has at least the benefit of reducing data collection and entry for claims reimbursement. The claims-related information may also be used to augment the other purposes of the software, described above.

What to be described below are two particular examples of patient assessment tools. One is a particular surgery patient assessment tool. The other an oncology patient assessment tool. It should be appreciated that other surgery or oncology patient assessment tools may be built similarly. It should also be appreciated that patient assessment tools for other disease or ailment may be similarly built. The examples provided below are only for the purpose of illustration.

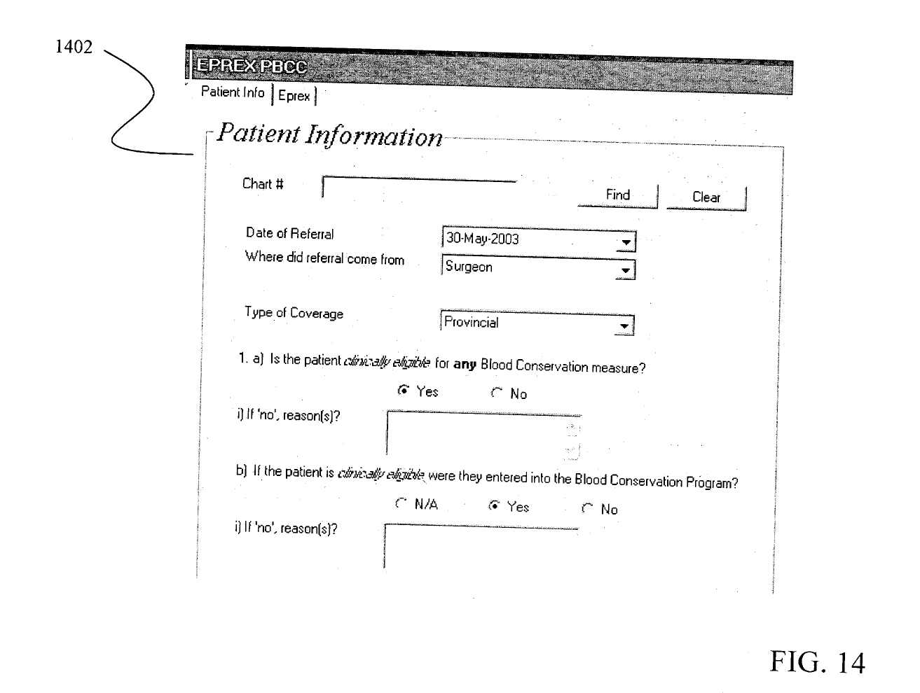

A particular example of patient assessment tool is patient module PBCC 1344, used for assessing conditions of surgery patients. FIG. 14 shows a portion of patient information screen 1402 displayed by PBCC module 1314. Patient-related information can be entered on this screen. Such information may include, for example, hospital/clinic chart number of a patient, type of insurance coverage a patient has and whether the patient is clinically eligible for any blood conservation measures.

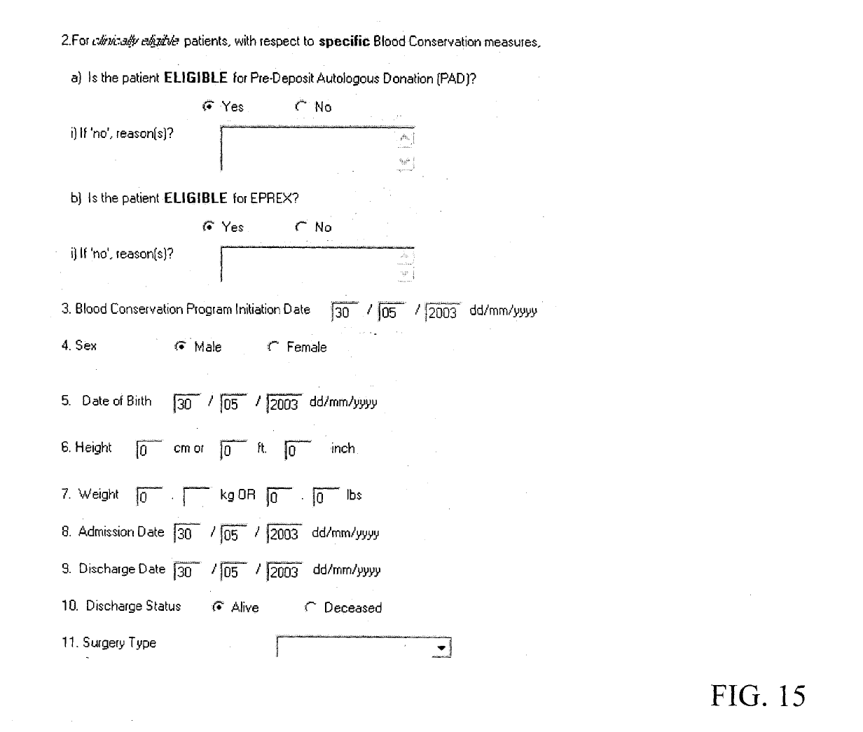

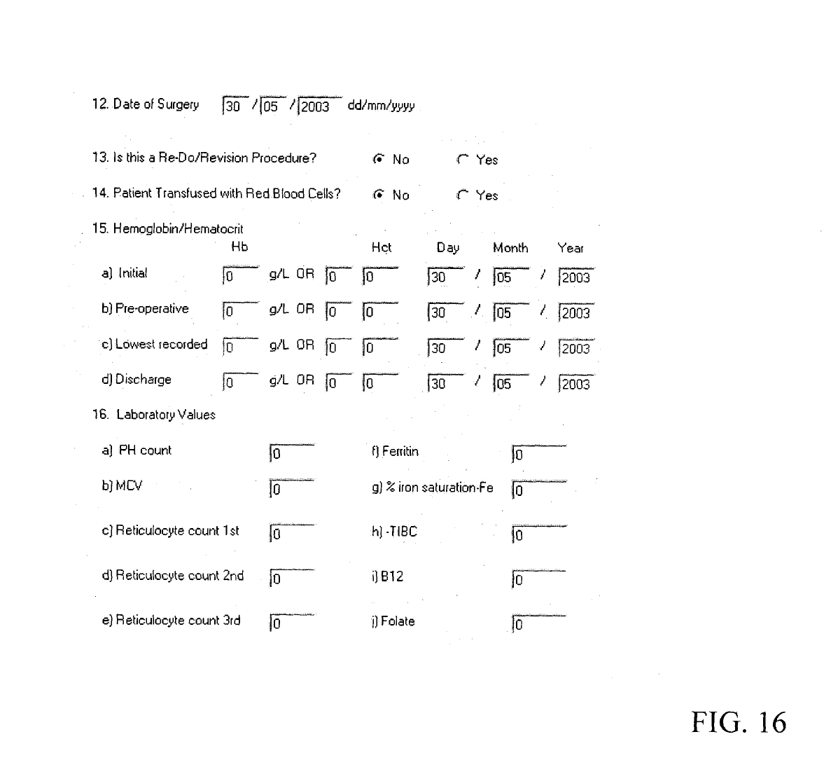

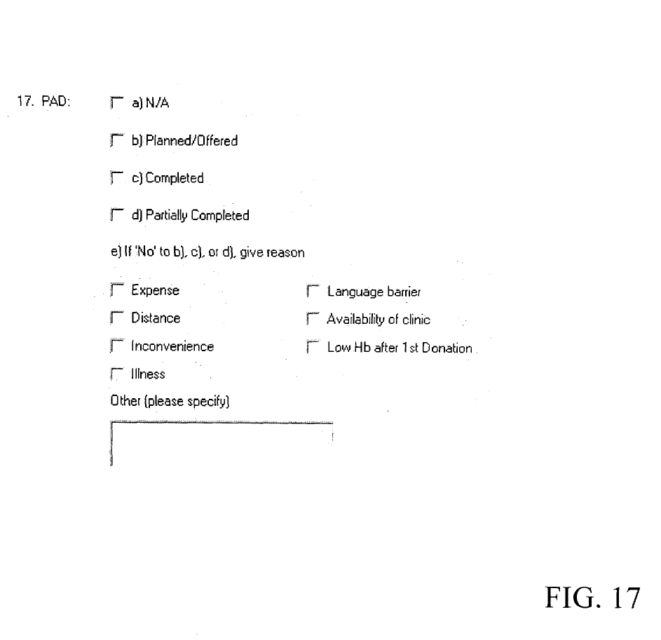

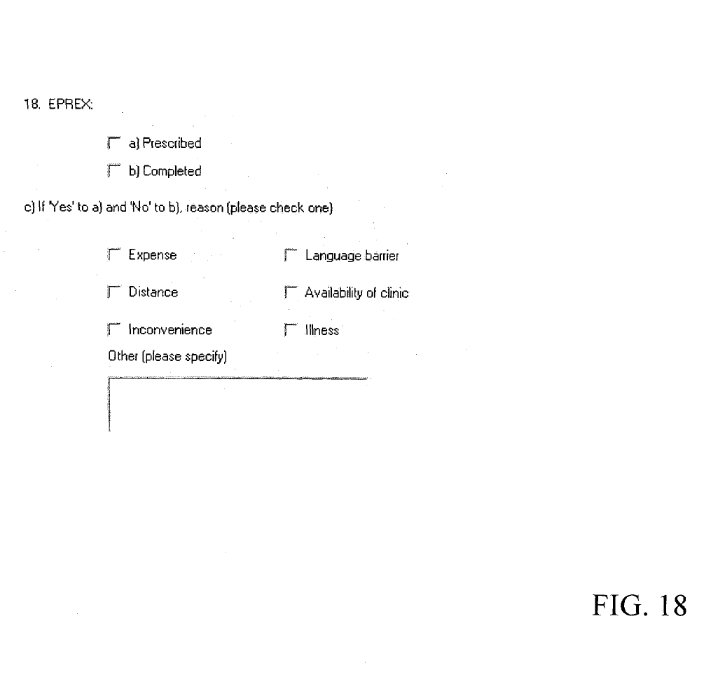

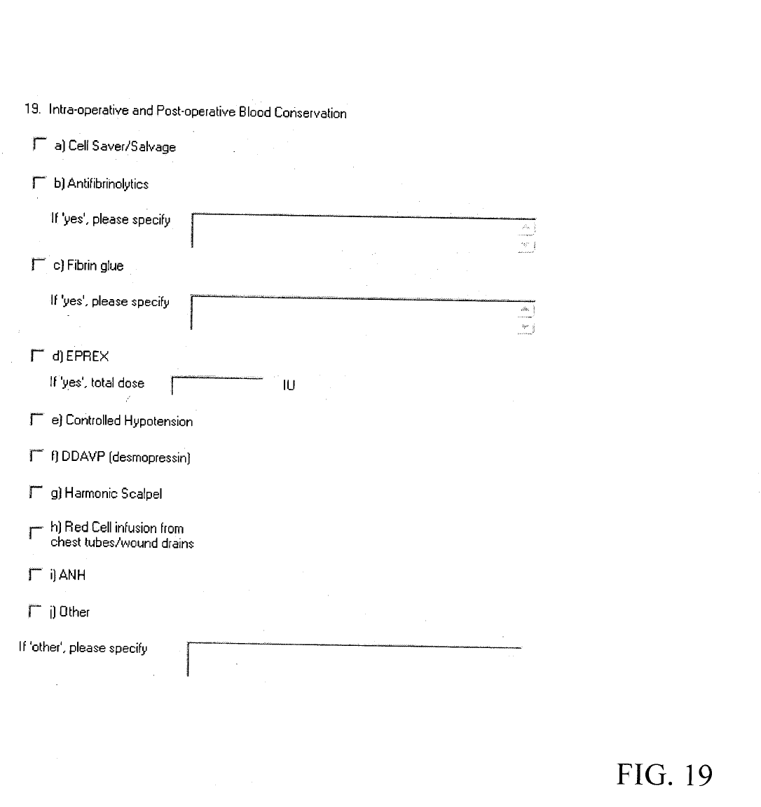

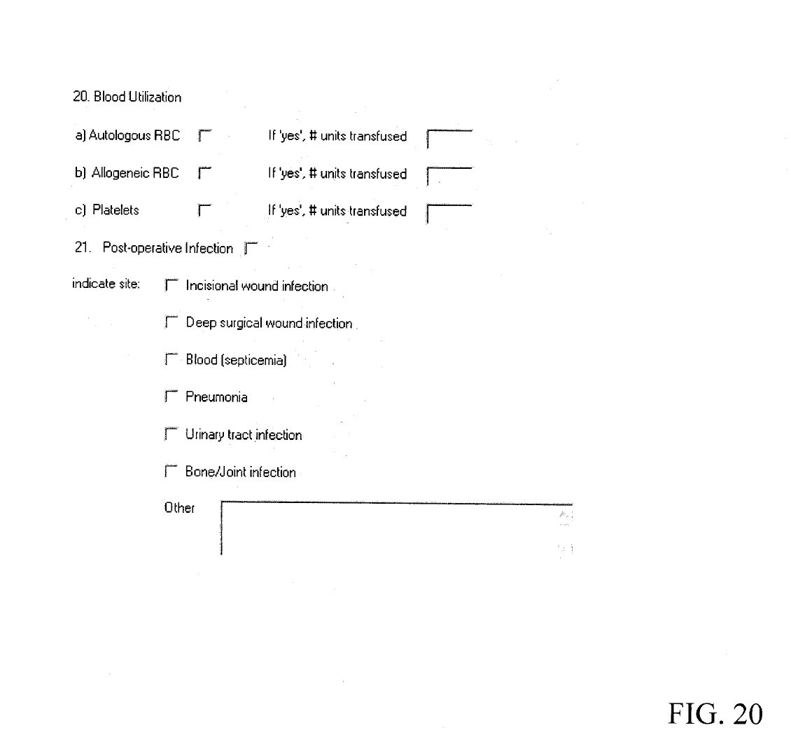

The remaining portions of patient information screen 1402 are shown in FIGS. 15 to 20. Information collected through these data entry screens may be transmitted to hospital application 1302 for storing in patient-related database 120. Such information may be used, for example, to pre-populate entries in a claim form, or other claim documentation for seeking pre-approval of a treatment, thus further reducing administrative burden of healthcare providers. Additionally, if any continued coverage request has been approved, information related to such continued coverage request may be saved in database 120 of the computer software system. Such information may be used to validate data received from patient modules 1312 to ensure that medications administered on patients are consistent with approved continued coverage requests. The data may also be used, for example, to access and improve patient care, and to support research.

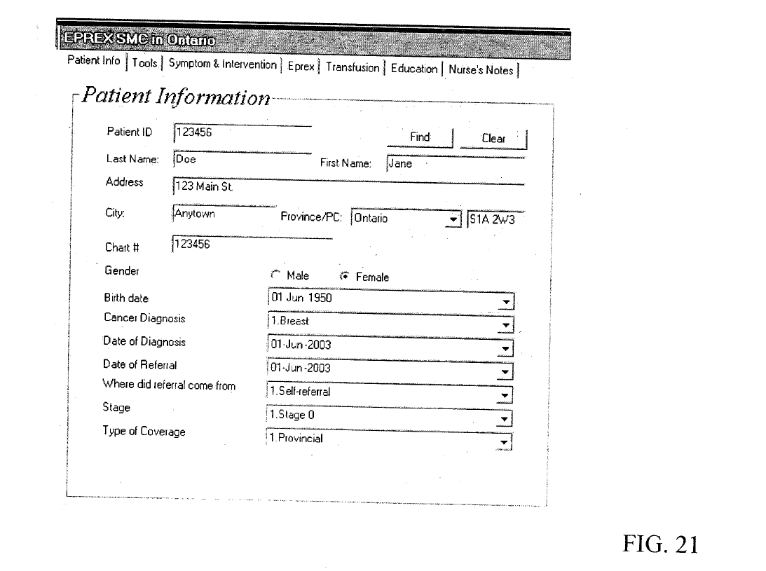

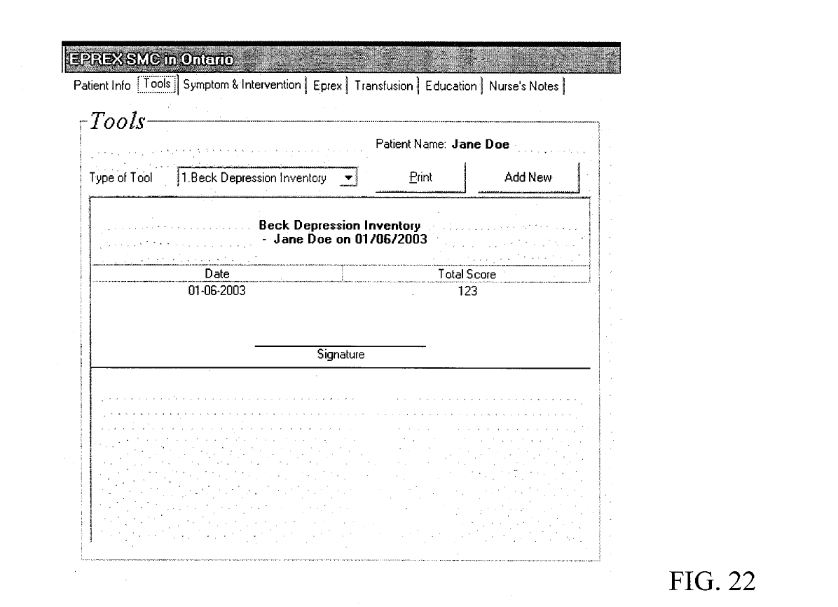

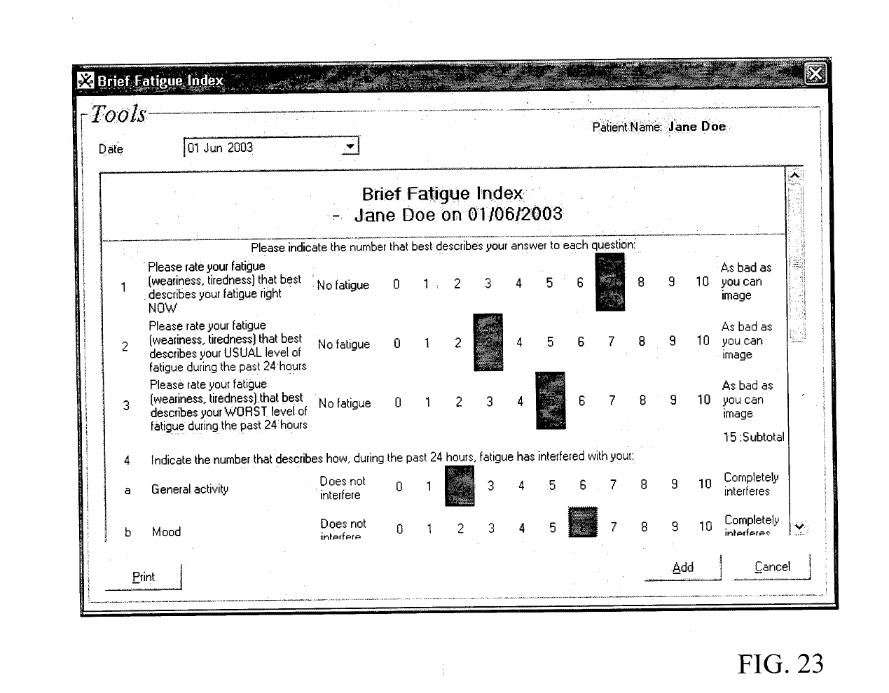

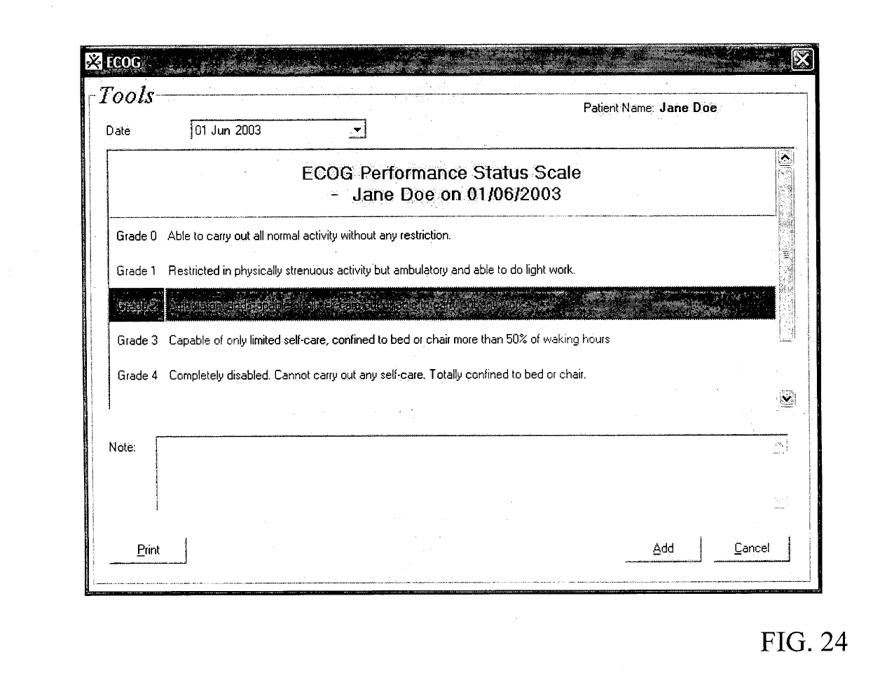

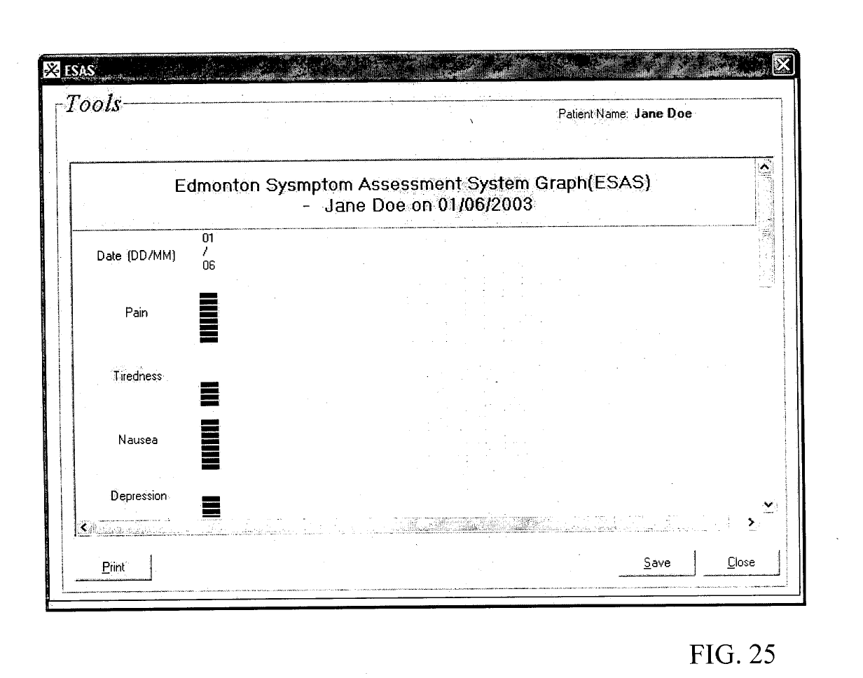

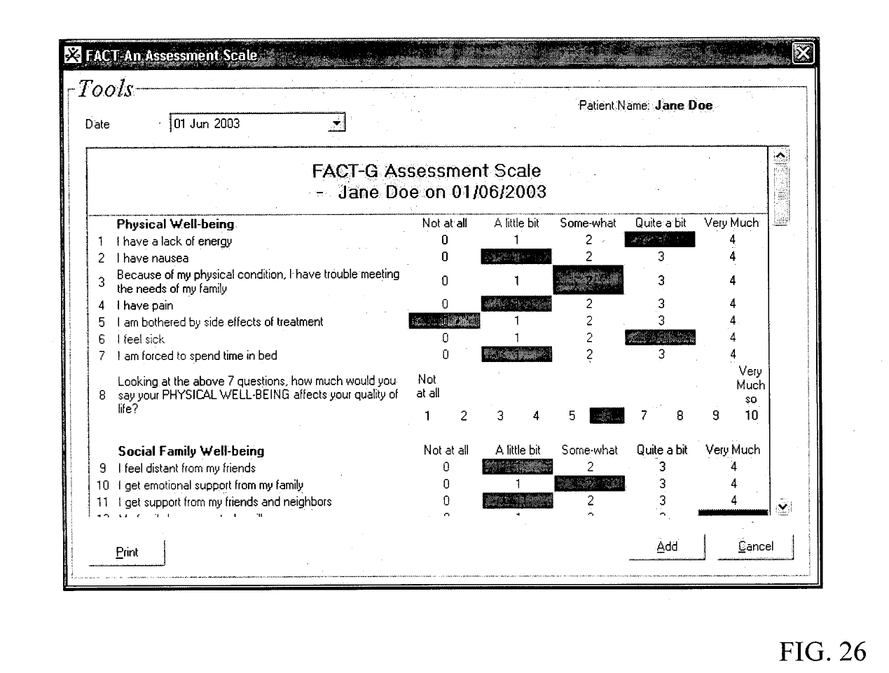

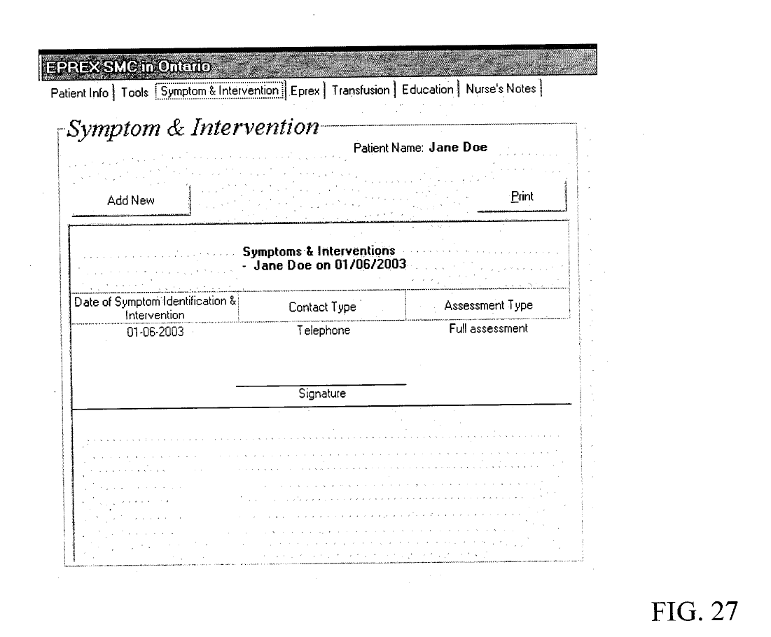

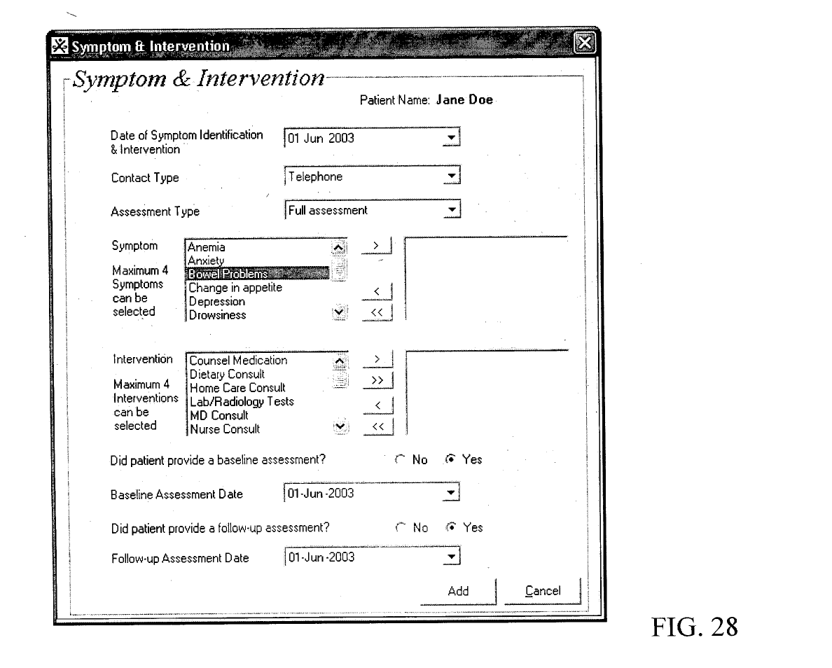

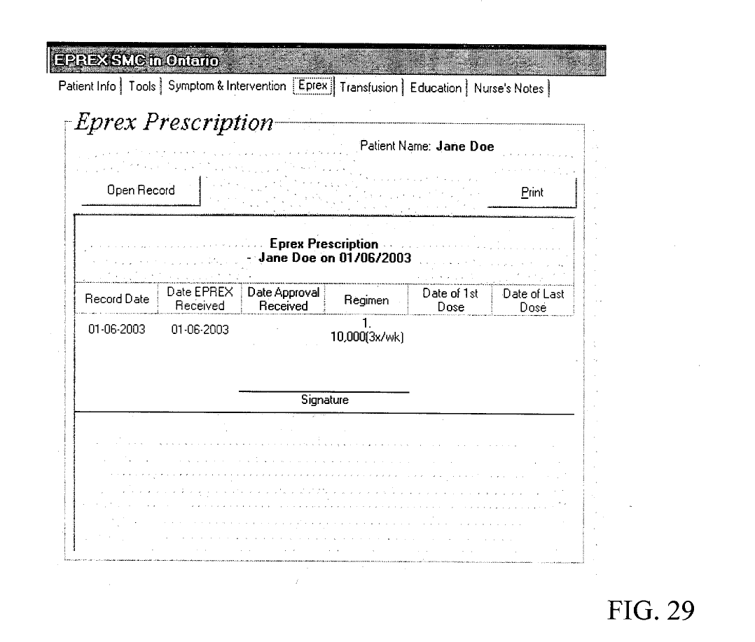

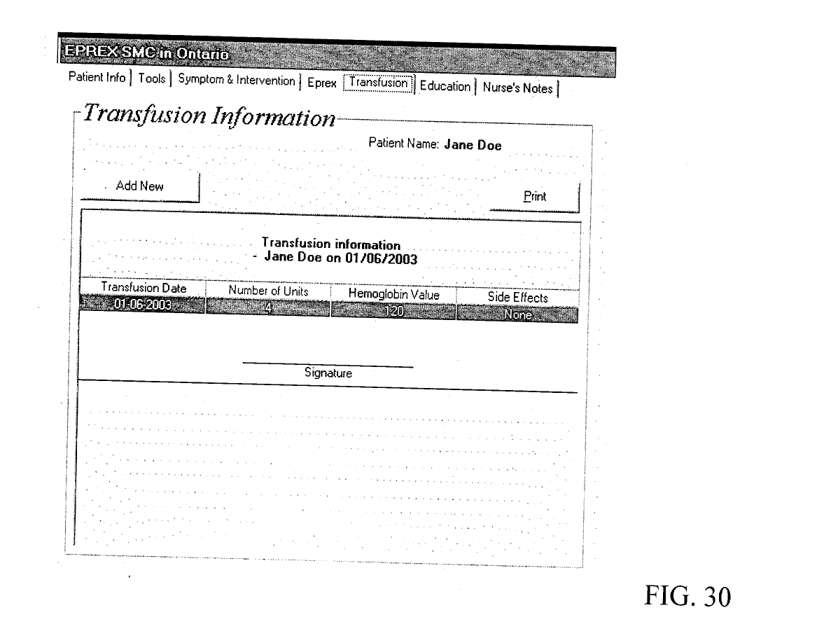

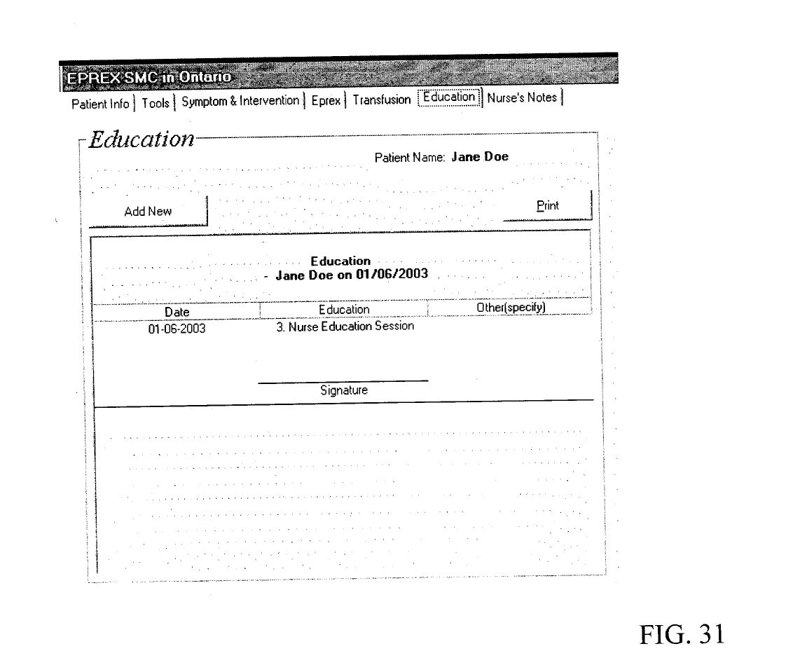

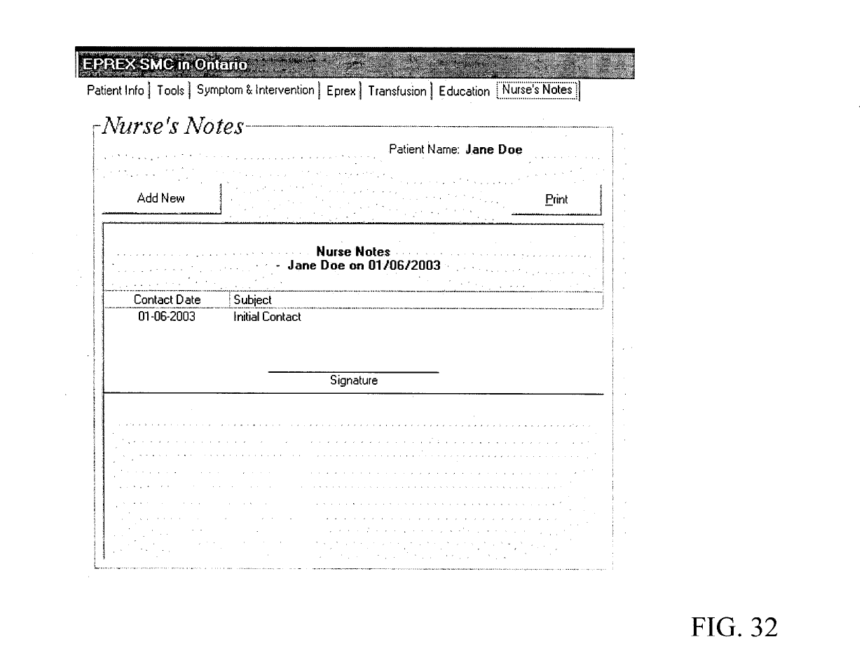

Patient module SMC 1316 is a particular example of patient assessment tool used to assess medical conditions of cancer patients. For example, FIG. 21 is Patient Information screen for entering general patient-related information. From this screen, a number of different functions of module SMC 1316 may be accessed through different “tabs”. FIG. 22 shows a screen accessed through tab Tools. Different Tools information, or different types of information about a patient, may be entered through “Type of Tool” drop-down button. FIGS. 23 to 26 show some exemplary input screens illustrating the range of information that may be entered into SMC module 1316. Other types of information relating to, for example, symptoms and intervention, or transfusion information, may also be entered using input screens shown in FIGS. 27 to 31. Additionally, a nurse may enter personalized comments or notes about the patient through Nurse's Notes screen accessible by clicking “Nurse's Notes” tab, as shown in FIG. 32.

Those skilled in the art will appreciate that numerous modifications, adaptations and variations may be made to the embodiments without departing from the scope of the invention.

What is claimed is:

1. A system for preparing and tracking an insurance claim for an insurance provider identified from a plurality of insurance providers for a pharmaceutical product for a patient from a plurality of patients, said system comprising:
a database for storing patient information relating to said patient, claim information relating to said insurance claim, form information relating to said plurality of insurance providers, provider information relating to said plurality of insurance providers and product information relating to said pharmaceutical product;
a software system operating on a computer for entering and processing said patient information, claim information, provider information and product information, said software system adapted to receive said patient information from a user, to identify said claim information utilizing in part said patient information and to track a status of said insurance claim as it is processed by said insurance provider.

2. The system of claim 1 wherein said software system further is adapted to generate a claim package for said insurance claim, said claim package comprising a claim form related to said insurance provider populated by data in said patient information and a covering letter addressed to said insurance provider providing further information relating to said patient and said pharmaceutical product.

3. The system of claim 2 wherein said product information comprises dosage information, treatment information and clinical study information.

4. The system of claim 3 wherein said software system is further adapted to selectively include said clinical study information as said further information in said covering letter.

5. The system of claim 4 wherein said software system tracks said status of said insurance claim as being one of at least being pending, filed, and rejected.

6. The system of claim 5 wherein said software system is further adapted to selectively generate an appeal package after said status of said insurance claim is set to being rejected, said appeal package comprising an appeal covering letter providing further information from said clinical study information.

7. The system of claim 6 wherein said software system is further adapted to generate a status report comprising claim status information relating to claims prepared for said plurality of patients.

8. The system of claim 7 wherein said software system is further adapted to track a plurality of physicians of patients that file insurance claims relating to said pharmaceutical product to said plurality of insurance providers and said database contains physician information relating to said plurality of physicians.

9. The system of claim 8 wherein said software system is further adapted to generate a report based one of a condition relating to said pharmaceutical product, said patient and a physician of said plurality of physicians.

10. The system of claim 9 wherein said database stores said patient information, said claim information, said provider information, said product information and said physician information in a plurality of tables and said software system is adapted to access and process said plurality of tables using SQL constructs.

11. A method of preparing and tracking an insurance claim for an insurance provider identified from a plurality of insurance providers for a pharmaceutical product for a patient from a plurality of patients, a status of said insurance claim being stored in a database accessible by a software system operating on a computer, said software system adapted to receive data relating to said insurance claim and to generate a claim package relating to said insurance claim, said method comprising the steps of:
receiving said patient information from a user by said software system;
providing product information relating to said pharmaceutical product for inclusion in said claim package for selection by said user;
generating said claim package utilizing said received patient information and product information;
tracking a status of said insurance claim; and
updating said status upon a user being notified of approval or rejection of the insurance claim.

12. The method of claim 11, wherein
said product information comprises dosage information, treatment information and clinical study information; and
said method further comprises providing said clinical study information into said insurance claim documentation in a form letter.

13. A method of assessing a patient, and preparing and tracking an insurance claim for an insurance provider identified from a plurality of insurance providers for a pharmaceutical product identified by said assessment for treatment of said patient from a plurality of patients, a status of said insurance claim being stored in a database accessible by a software system operating on a computer, said software system adapted to receive data relating to said insurance claim and to generate a claim package relating to said patient assessment and said insurance claim, said method comprising the steps of:
receiving patient assessment information from a user by said software system;
providing diagnosis information based on said patient assessment information;
providing treatment information based on said diagnosis; and
when said treatment information identifies a pharmaceutical product:
receiving said patient information from a user by said software system;
providing product information relating to said pharmaceutical product for inclusion in said claim package for selection by said user;
generating said claim package utilizing said received patient information and product information;
tracking a status of said insurance claim; and
updating said status upon a user being notified of approval or rejection of the insurance claim.
